(19) United States
(12) Patent Application Publication
(10) Pub. No.: US 2024/0157329 A1
(43) Pub. Date: May 16, 2024

(54) ADSORBENT, POLYMER, AND ADSORPTION APPARATUS

(71) Applicant: FUJIFILM Corporation, Tokyo (JP)

(72) Inventors: Shinsuke TOKUOKA, Ashigarakami-gun (JP); Shigeki UEHIRA, Ashigarakami-gun (JP); Masato SENOO, Ashigarakami-gun (JP); Koji HIRONAKA, Ashigarakami-gun (JP)

(73) Assignee: FUJIFILM Corporation, Tokyo (JP)

(21) Appl. No.: 18/531,833

(22) Filed: Dec. 7, 2023

Related U.S. Application Data
(63) Continuation of application No. PCT/JP22/25058, filed on Jun. 23, 2022.

(30) Foreign Application Priority Data
Jun. 23, 2021 (JP) 2021-104235
Feb. 18, 2022 (JP) 2022-023768

(51) Int. Cl. B01J 20/26; B01J 20/287

(52) U.S. Cl. CPC B01J 20/262; B01J 20/287; B01J 2220/50

(57) ABSTRACT

A polymer that contains, in a molecular chain constituting a main chain, a skeleton derived from a dehydroabietic acid compound, an adsorbent that contains the polymer, and an adsorption apparatus that has the adsorbent.

### CROSS-REFERENCE TO RELATED APPLICATIONS

This application is a Continuation of PCT International Application No. PCT/JP2022/025058 filed on Jun. 23, 2022, which claims priority under 35 U.S.C. § 119 (a) to Japanese Patent Application No. 2021-104235 filed in Japan on Jun. 23, 2021, and Japanese Patent Application No. 2022-023768 filed in Japan on Feb. 18, 2022. Each of the above applications is hereby expressly incorporated by reference, in its entirety, into the present application.

### BACKGROUND OF THE INVENTION

### 1. Field of the Invention

The present invention relates to an adsorbent, a polymer used for the adsorbent, and an adsorption apparatus.

### 2. Description of the Related Art

In recent years, from the viewpoint of reduction of a load on the global environment, saving of resources, environmental compatibility, and the like, removal of petroleum from resources has been studied, and various natural resources have been attracting attention. In the field of plastics as well, the removal of petroleum has been proceeding. In place of synthetic polymers made from petroleum, the development and use of biomass polymers made from compounds derived from plants and animals (biomass) such as sugar cane and corn, as well as biodegradable polymers, are being considered. For example, polylactic acid made from lactic acid obtained by fermentation of glucose has been widely used as a packaging material.

Meanwhile, as a component derived from a natural product (preferably, a plant), there is rosin that can be collected from pine resin or the like. This rosin is composed of various carboxylic acids, and it has been studied to use abietic acid among the carboxylic acids for a polymer material. For example, in JP5395650B, “a dehydroabietic acid polymer having a repeating unit containing a dehydroabietic acid skeleton derived from dehydroabietic acid” is described. In addition, in JP5714442B, “a polyamide polymer, comprising a partial structure represented by the specific formula (C), the partial structure constituting a portion of a main chain” is described. Furthermore, in JP5734779B, “a polyester polymer comprising: a repeating unit derived from a dicarboxylic acid compound containing a partial structure represented by the specific formula (C); and a repeating unit derived from a diol compound containing a ring structure, the partial structure represented by formula (C) constituting a portion of a main chain” is described.

### SUMMARY OF THE INVENTION

Each of the polymers described in JP5395650B, JP5714442B, and JP5734779B has been studied and developed by the present applicant, and it has been proposed to use the polymers for molded bodies such as a member of an electronic apparatus, a film, and a sensor lens.

Such a polymer that contains a skeleton derived from a dehydroabietic acid compound satisfies environmental considerations. Thus, the polymer is desired to be applied to a wider range of applications. Therefore, the present inventors have continuously studied a chemical structure, properties, and new applications of the polymer that contains a skeleton derived from a dehydroabietic acid compound. As a result, it has been found that the polymer that contains a skeleton derived from a dehydroabietic acid compound exhibits an adsorption characteristics, particularly characteristics of adsorbing and removing hydrophobic organic substances in water, and furthermore, the polymer is promising as an adsorbent without impairing its adsorption characteristics even in a case of being applied to the application as an adsorbent in the related art. Based on these findings, the present inventors further repeated examinations and have accomplished the present invention.

An object of the present invention is to provide an adsorbent formed of a polymer having environmental compatibility, and a polymer used for the adsorbent. Another object of the present invention is to provide an adsorption apparatus using the adsorbent.

That is, the above-described objects have been achieved by the following means.
<1> An adsorbent comprising a polymer that contains a skeleton derived from a dehydroabietic acid compound in a molecular chain constituting a main chain.
<2> The adsorbent according to <1>, in which the skeleton derived from the dehydroabietic acid compound has a structure represented by Formula (U),

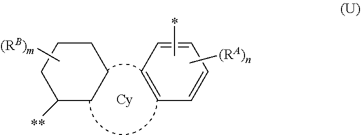

in Formula (U), R^{A} and R^{B} each represent an alkyl group having 1 to 6 carbon atoms or an alkenyl group having 2 to 6 carbon atoms, n is an integer of 0 to 4, and m is an integer of 0 to 7, Cy represents a saturated or unsaturated 6-membered ring or 7-membered ring which may contain a heteroatom, and * and ** each represent a bonding part in a case where the structure is incorporated into the molecular chain, where, in a case where n is 4, one of R^{A}'s has the bonding part *.
<3> The adsorbent according to <1> or <2>, in which the polymer is selected from a polymer that contains, in a molecular chain constituting a main chain, a constituent represented by Formula (A1) or (A2),

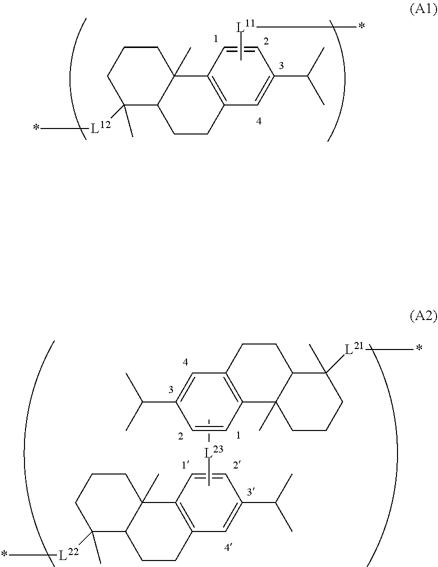

in Formulae (A1) and (A2), L¹¹, L¹², L²¹, L²², and L²³ each represent a divalent linking group, and * represents a bonding part in a case where the constituent is incorporated into the molecular chain.
<4> The adsorbent according to any one of <1> to <3>, in which the polymer contains, in the molecular chain, a constituent derived from a polyamine compound or a polyol compound.
<5> The adsorbent according to <4>, in which the polyamine compound contains a secondary amino group.
<6> The adsorbent according to <4> or <5>, in which the polyamine compound contains a heterocyclic structure.
<7> The adsorbent according to any one of <1> to <6>, in which the adsorbent is used in a liquid containing water.
<8> The adsorbent according to any one of <1> to <7>, in which an adsorbate is an organic substance.
<9> The adsorbent according to <8>, in which the organic substance is a compound having a clogD>0.

<10> An adsorption apparatus comprising the adsorbent according to any one of <1> to <9>.

<11> A polymer comprising, in a molecular chain constituting a main chain: a constituent that contains a skeleton derived from a dehydroabietic acid compound; and a constituent derived from a polyamine compound that contains a secondary amino group.
<12> The polymer according to <11>, in which the polyamine compound contains a heterocyclic structure.

The adsorbent and the polymer according to the present invention are those using a plant-derived compound, have environmental compatibility, and exhibit excellent adsorption characteristics. In addition, the adsorption apparatus according to the present invention has the above-described adsorbent, and can adsorb an adsorbate by utilizing the adsorption characteristics thereof.

The above-described and other characteristics and advantages of the present invention will be further clarified by the following description with reference to appropriately accompanied drawings.

### BRIEF DESCRIPTION OF THE DRAWINGS

FIG. 1 is a ¹H-NMR chart of 12-carboxydehydroabietic acid (a-1), which is synthesized in Synthesis Example M1.

FIG. 2 is a ¹H-NMR chart of 12-carboxydehydroavietic acid chloride (a-1C), which is synthesized in Synthesis Example M2.

FIG. 3 is a ¹H-NMR chart of dicarboxylic acid (a-2), which is synthesized in Synthesis Example M3.

FIG. 4 is a graph showing a test result of Reference Test Example 1.

### DESCRIPTION OF THE PREFERRED EMBODIMENTS

In the present invention, a numerical range represented by using “to” means a range including numerical values described before and after “to” as a lower limit value and an upper limit value. In a case where multiple numerical ranges are set and described in a stepwise manner, the upper limit value and the lower limit value, which form a numerical range, are not limited to a specific combination of the upper limit value and the lower limit value, and a numerical range can be formed by appropriately combining the upper limit value and the lower limit value of each numerical range.

Regarding the expression of compounds in the present invention (for example, in a case of being referred to with “compound” at the end), the scope of the expression includes not only the compound but also salts and ions thereof. In addition, the scope of the expression includes derivatives partially modified by introducing a substituent thereinto, to the extent that the effect of the present invention is not impaired.

In the present invention, (meth)acryl means one or both of acryl and methacryl. The same applies to (meth)acrylate.

In the present invention, a substituent, a linking group, or the like (hereinafter, referred to as a substituent or the like), which is not specified regarding whether to be substituted or unsubstituted, may have an appropriate substituent. Accordingly, even in a case where a YYY group is simply described in the present invention, this YYY group includes not only an aspect having a substituent but also an aspect not having a substituent. The same applies to a compound that is not specified in the present specification regarding whether to be substituted or unsubstituted. Examples of the preferred substituent include a substituent T described later.

In the present invention, in a case where a plurality of substituents or the like represented by a specific reference numeral are present, or a plurality of substituents or the like are simultaneously or alternatively defined, individual substituents or the like may be the same as or different from each other. In addition, unless specified otherwise, in a case where a plurality of substituents or the like are adjacent to each other, the substituents may be linked or fused to each other to form a ring.

### Adsorbent

An adsorbent according to an embodiment of the present invention contains a polymer that contains, in a molecular chain constituting a main chain, a skeleton derived from a dehydroabietic acid compound. This adsorbent may consist of a polymer itself or may consist of a polymer and other components, which is appropriately selected depending on the applicable form, the applicable use, and the like. For example, in a case where the adsorbent is used for the purpose of filling a column or the like, particles consisting of a polymer itself are employed.

The adsorbent according to the embodiment of the present invention can be applied without particular limitation to the use to which an adsorbent in the related art such as activated carbon or zeolite is applied, and can be used in various applicable uses such as purification or resource recovery of wastewater and rivers or oceans, adsorption and removal of specific substances produced from cell culture solutions, adsorption and removal of specific substances in in vitro diagnostic agents, removal of endotoxins (medical adsorbents), carriers for various types of chromatography, test drugs, carriers for bioreactors and the like, and sustained release carriers, for example. Examples of the applicable use for removing endotoxins include oral pharmaceuticals such as an adsorbent for uremia, an adsorption and separation column used in a blood purification device such as hemodialysis or apheresis, and the like. Details of a method for using the adsorbent and the like will be described later.

Hereinafter, preferred embodiments of the present invention will be mainly described in detail.

### Polymer

The polymer according to an embodiment of the present invention is a polymer that contains a skeleton derived from a dehydroabietic acid compound in a molecular chain (generally, each of the molecular chains which are linearly connected) constituting a main chain. In the present invention, the inclusion of the skeleton in the molecular chain constituting the main chain means that the skeleton is contained in a partial structure which forms the main chain among repeating units constituting a polymer. The skeleton may be contained in the partial structure corresponding to a side chain of the polymer as long as the skeleton is contained in the molecular chain constituting the main chain; however, it is preferable that the skeleton is not contained in the partial structure. In addition, regarding the skeleton, the skeleton itself may be contained in a molecular chain as a constituent or a repeating unit, and may be contained as a constituent or repeating unit in which a linking group or the like is introduced into the above-described skeleton depending on the type of the polymer or the like. Examples of the linking group introduced into the above-described skeleton include linking groups defined in L¹¹ to L²² described later.

The polymer according to the embodiment of the present invention may be a homopolymer obtained from a dehydroabietic acid compound (such as dehydroabietic acid or a derivative thereof) as a raw material compound and consisting of a constituent containing a skeleton derived from this dehydroabietic acid compound, or may be a copolymer consisting of the constituent containing the skeleton and a constituent derived from another compound.

In the present invention, the “skeleton derived from a dehydroabietic acid compound” includes a skeleton that can be derived from dehydroabietic acid to the extent that the effect of the present invention is not impaired, in addition to the skeleton derived from dehydroabietic acid. The skeleton derived from the dehydroabietic acid compound is not particularly limited, but examples thereof include the following skeletons (AA-1) to (AA-10), as well as in each skeleton, a skeleton whose carbonyloxy group or —CH₂O— group is substituted with a linking group L¹² or L²² described later, and for example, in each skeleton, each skeleton having a carbonyloxy group or —CH₂O— group from which an oxygen atom is removed. Among the skeletons, the skeleton (AA-1), (AA-3), or (AA-10), or each skeleton with removal of an oxygen atom from these skeletons is preferred, and the skeleton (AA-1) or a skeleton with removal of an oxygen atom from this skeleton is more preferable.

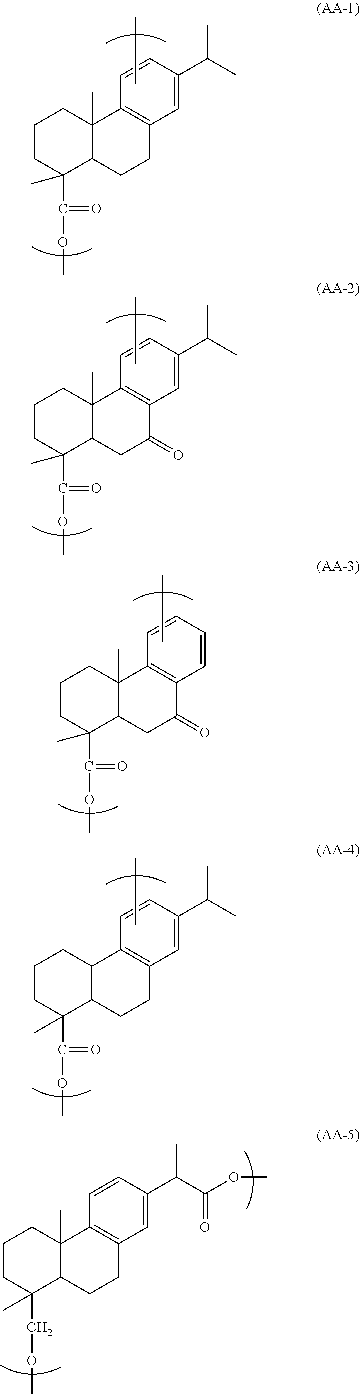

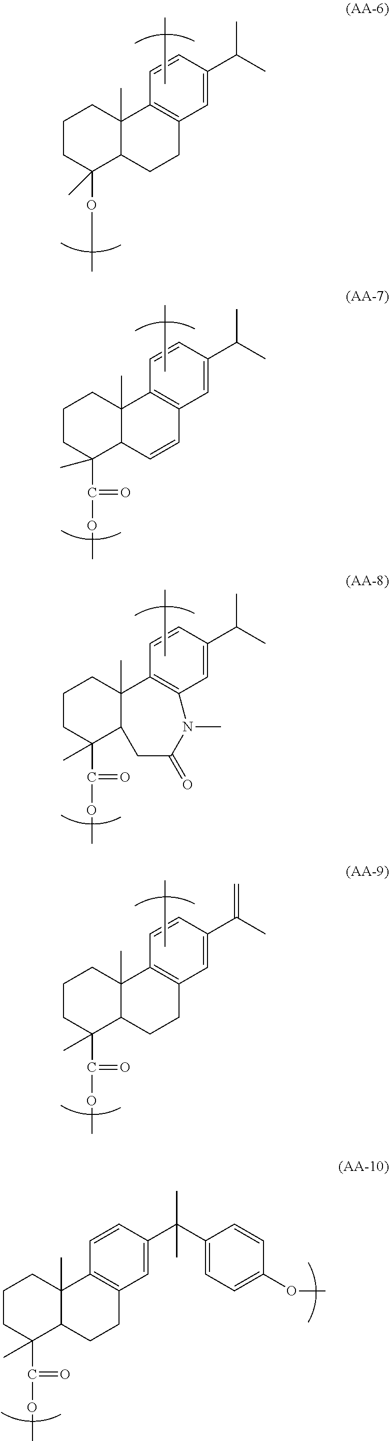

The skeleton derived from the dehydroabietic acid compound described above may further have a substituent. The substituent which the skeleton may have is not particularly limited and can be appropriately selected from a substituent T described later, and examples thereof include an alkyl group, an alkoxy group, a halogen atom, a hydroxyl group, a carbonyl group, a nitro group, an amino group, and the like.

The polymer according to the embodiment of the present invention preferably contains a structure represented by Formula (U) as the skeleton derived from the dehydroabietic acid compound.

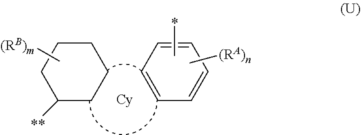

In Formula (U), R^{A} and R^{B} each represent an alkyl group having 1 to 6 carbon atoms or an alkenyl group having 2 to 6 carbon atoms. n is an integer of 0 to 4, and m is an integer of 0 to 7. The ring Cy is a ring formed to contain carbon atoms constituting a cyclohexane ring and a benzene ring in Formula (U), and may be a saturated or unsaturated 6-membered ring which may contain a heteroatom or a saturated or unsaturated 7-membered ring which may contain a heteroatom. In the formula, * and ** each represent a bonding part (bonding site) in a case where the above-described structure is incorporated into the molecular chain constituting the main chain. For the sake of convenience, the bonding parts * and ** are described as carbon atoms constituting the cyclohexane ring or the benzene ring in Formula (U); however, in the present invention, the bonding parts * and ** may also be atoms constituting a group bonded to these carbon atoms as shown in Formula (U3) below in addition to the carbon atoms constituting the cyclohexane ring or the benzene ring, for example. In a case where such an atom serves as the bonding part **, examples of the structure of the group containing the bonding part ** include a linking group L¹² or L²² described later. In addition, in a case where n is 4, one of R^{A}'s has the bonding part *. In this case, the bonding part is a carbon atom with removal of one hydrogen atom from an alkyl group or alkenyl group, which can be adopted as R^{A}.

R^{A} is preferably an alkyl group having 1 to 4 carbon atoms, and more preferably an i-propyl group.

R^{B} is preferably a methyl group.

The ring Cy is preferably a cyclohexane ring or a cyclohexene ring, and more preferably a cyclohexane ring. The ring Cy may have a substituent, and examples of the substituent include a substituent T described later, an oxo group (═O), and the like, and a group which can be adopted as R^{B} is preferable.

Here, in the structure represented by Formula (U), a fused ring moiety (a carbon atom shared by two rings) between the cyclohexane ring and the ring Cy may have a substituent, and in this case, the substituent is construed as R^{B} of Formula (U), and the number of substituents thereof is counted as m described below.

n is preferably an integer of 0 to 3, and more preferably 1.

m is preferably an integer of 0 to 5, and more preferably 2.

A position of R^{A} on the benzene ring is not particularly limited, and examples thereof include the position shown in (U2) described later. A position of the bonding part * on the benzene ring is not particularly limited.

The structure represented by Formula (U) described above is preferably a structure represented by Formula (U1) described below.

In Formula (U1), R^{A}, R^{B}, m, n, *, and ** have the same meanings as those in Formula (U). R^{C} has the same meaning as R^{B}. p represents an integer of 0 to 4, preferably represents an integer of 0 to 2, and more preferably represents 0.

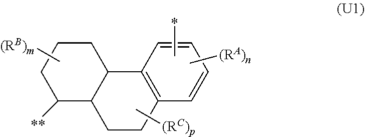

The structure represented by Formula (U) described above is more preferably a structure represented by Formula (U2) described below. In Formula (U2), * and ** have the same meanings as those in Formula (U).

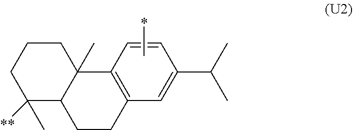

dehydroabietic acid is a component constituting rosin contained in pine resin of plant origin. That is, since a natural origin material can be used as a matrix thereof, the offset to the amount of carbon dioxide emissions occurs; thereby, it is possible to significantly reduce emission equivalent as compared to materials derived from fossil fuels. The material is environment-compatible and derived from a biomass resource, which is desired as a next-generation material. Note that, the skeleton derived from the dehydroabietic acid compound and the structures represented by Formulae (U), (U1), and (U2) may be collectively referred to as a dehydroabietane main skeleton, and this may also be referred to as a “DHA main skeleton”.

In a preferred embodiment of the present invention, examples of an important skeleton structure in the DHA main skeleton include a structure represented by Formula (U3) or (U4). A structure represented by Formula (U3) is referred to as a skeleton derived from dehydroabietane (DA skeleton), and a structure represented by Formula (U4) and a structure with removal of an oxy group from a carbonyloxy group in this structure is referred to as a skeleton derived from dehydroabietic acid (DAA skeleton).

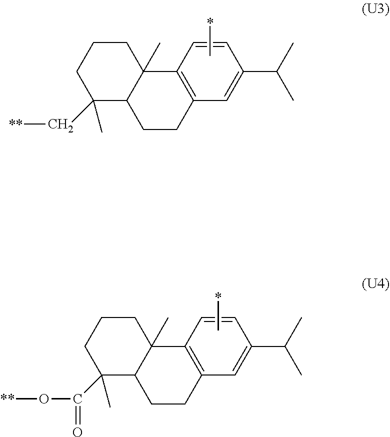

Each of the structures represented by Formulae (U) to (U4) is incorporated into a molecular chain of the polymer as it is or with an appropriate linking group incorporated, depending on the type of the polymer according to the embodiment of the present invention. Such a linking group is not particularly limited, but examples thereof include linking groups defined by L¹¹ to L²² and the like described later. In the skeleton represented by Formula (U4), it is also possible to incorporate a carbonyloxy group into the molecular chain of the polymer by substituting the carbonyloxy group with the linking group L¹² or L²² described later.

The polymer according to the embodiment of the present invention is preferably selected from a polymer containing, as the constituent containing the skeleton derived from the dehydroabietic acid compound, a constituent represented by Formula (A01) or (A02), and more preferably selected from a polymer containing a constituent represented by Formula (A11) or (A12), and still more preferably selected from a polymer containing a constituent represented by Formula (A1) or (A2). Note that, in the following constituents, the numbers shown around the benzene ring indicate the position numbers of carbon atoms constituting the benzene ring in each fused ring.

In each formula, R^{A}, R^{B}, R^{C}, Cy, m, n, and p have the same meanings as those in Formulae (U) and (U1). * represents a bonding part in a case where each constituent is incorporated into a molecular chain constituting a main chain.

The constituent represented by Formula (A01) is a constituent containing the DHA main skeleton, and the constituent represented by Formula (A02) is a constituent containing a dimer skeleton of the DHA main skeleton.

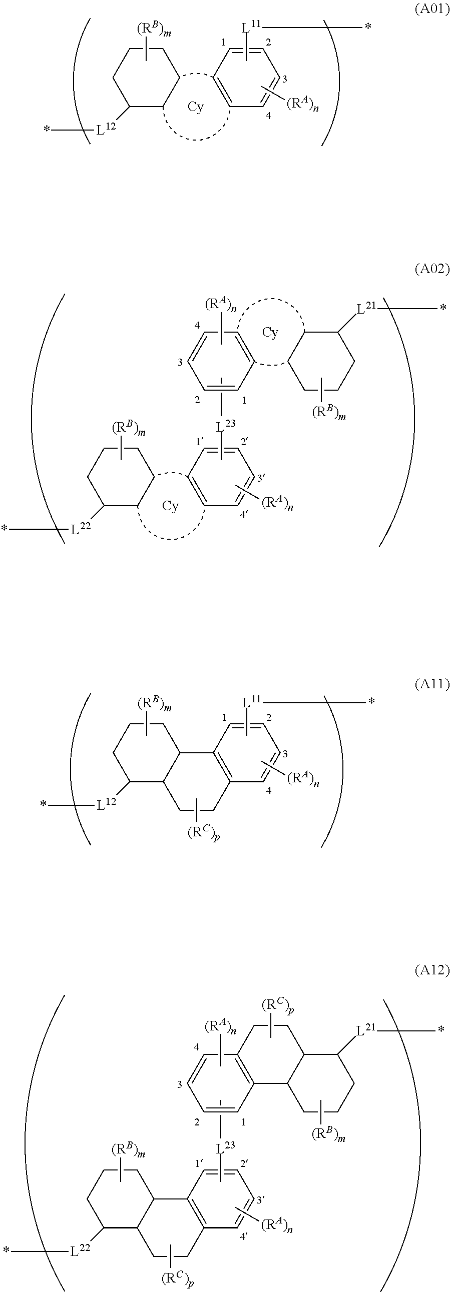

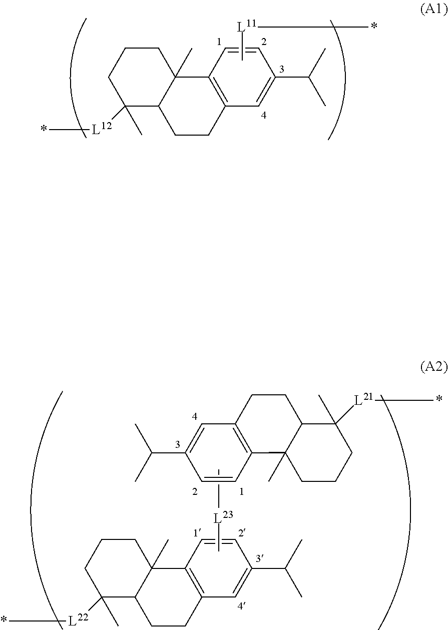

In Formulae, L¹¹, L¹², L²¹, L²², L²², and L²³ each represent a divalent linking group. The preferred ranges of these linking groups will be described in the description of the preferred embodiments of each polymer described later, but the preferred ranges thereof are collectively shown below.
(1) A case where the constituent represented by each formula is a constituent derived from polycarboxylic acid
L¹¹: *—CO-L¹³-** or *-L¹³-CO—** (L¹³ represents a single bond or a linking group. The details thereof will be described later)
L¹², L²¹, and L²²: Carbonyl group
L²³: Oxygen atom, sulfur atom, carbonyl group, sulfonyl group, alkylene group, alkenylene group, arylene group, single bond, or group formed in combination thereof
(2) A case where the constituent represented by each formula is a constituent derived from polyol
L¹¹: *-L^{1A}-O—** (L^{1A} represents a single bond or a linking group. The details thereof will be described later)
L¹², L²¹, and L²²: *—CH₂—O—**
L²³: the same meaning as L²³ in the above (1)

In Formulae (A01), (A11), and (A1), it is preferable that the linking group L¹¹ is bonded to the carbon atom represented by the 2-position of the benzene ring. In addition, in Formulae (A02), (A12), and (A2), it is preferable that the linking group L²³ is bonded to the carbon atom represented by the 2-position or 2′-position of the benzene ring.

A constituent having the above-described DHA main skeleton or the constituent having a dimer skeleton thereof may constitute a homopolymer by itself; however, the constituent preferably constitutes a polymer (for example, a copolymer, a sequential polymerization (polycondensation, polyaddition, or addition condensation) polymer, and other polymers) together with another constituent (copolymerization component). In the sequential polymerization polymer, the constituent containing a DHA main skeleton or a dimer skeleton thereof is regarded as an appropriate constituent depending on the type of the polymer, and a polycarboxylic acid constituent is preferred. The sequential polymerization polymer is not particularly limited, but examples thereof include polyester, polyamide, polyurethane, polyurea, polyimide, and the like. Among these, polyester and polyamide are preferable in terms of adsorption characteristics. A polyester having repeating units consisting of a constituent (a polycarboxylic acid constituent) containing a DHA main skeleton or a dimer skeleton thereof and a constituent derived from a polyol compound described later, or a polyamide repeating units consisting of a constituent (a polycarboxylic acid constituent) containing a DHA main skeleton or a dimer skeleton thereof and a constituent derived from a polyamine compound described later are preferred.

In the present invention, the polyester may have a linking group that has an oxycarbonyl group, and a part of the polyester may have a polycarbonate structure. The same applies to the polyamide, and the amide group may be contained in the linking group, and a part thereof may be an oxycarbonyl group, a polyimide structure, a polyurea structure, a polyurethane structure, or the like.

The other constituent (copolymerization component) can be appropriately selected depending on the type of the polymer and the like. Examples of the preferred constituent include a “structural unit” described in paragraphs to of JP2014-017464A, the content of which is incorporated as a part of the description of the present specification as it is.

The polymer according to the embodiment of the present invention also contains a derivative formed of a constituent containing a DHA main skeleton or a dimer skeleton thereof, to which a chemical treatment or the like is applied. In addition, the polymer according to the embodiment of the present invention may contain at least one of the other constituent that does not contain a DHA main skeleton or a dimer skeleton thereof, as necessary.

The total content of the constituent (for example, the repeating unit represented by Formula (A1) and the constituent represented by Formula (A2)) having a DHA main skeleton or a dimer skeleton thereof, which constitutes the polymer according to the embodiment of the present invention is not particularly limited, but is preferably 10% by mole or more, more preferably 15% by mole or more, and still more preferably 20% by mole or more with respect to the total amount of constituents constituting the polymer (for example, the total amount of a constituent derived from a polycarboxylic acid compound and a constituent derived from a polyol compound in an ester-based polymer). The upper limit thereof is not particularly limited, but is practically 70% by mole or less and preferably 50% by mole or less.

The total content of the other constituents is not particularly limited and is appropriately determined, and in a case of the sequential polymerization polymer, the total content is an equimolar amount with respect to the constituent having the DHA main skeleton.

Hereinafter, in addition to the constituent that contains a DHA main skeleton or a dimer skeleton thereof and is a preferred form in the polymer according to the embodiment of the present invention, a polymer (a polyester polymer and a polyamide polymer) that contains, in a molecular chain constituting a main chain, a constituent derived from the polyamine compound or the polyol compound as a constituent different from the above-described constituent will be described.

In a constituent represented by (A01), (A11), or (A1) described above (hereinafter, may be collectively referred to as a constituent represented by Formula (A1) or the like), a constituent represented by (A02), (A12), or (A2) described above (hereinafter, may be collectively referred to as a constituent represented by Formula (A2) or the like), five linking groups of L¹¹, L¹², L²¹, L₂₂, L²³, and L²³ are present, but for the four linking groups excluding L²³, appropriate linking groups are selected depending on the type of the polymer, and preferred linking groups vary.

### (1) Polyester Polymer [I]

A polyester polymer [I] preferably has at least one of the constituent represented by Formula (A1) or the like or the constituent represented by Formula (A2) or the like, as a constituent derived from a polycarboxylic acid compound, and has a repeating unit consisting of a constituent derived from a polyol compound.

### (Constituent Derived From Polycarboxylic Acid Compound)

The polycarboxylic acid compound from which this constituent is derived is not particularly limited, and a dicarboxylic acid compound is preferred.

In the polyester polymer [I], in a case where at least one of the constituent represented by Formula (A1) or the like and the constituent represented by Formula (A2) or the like is a constituent derived from a polycarboxylic acid compound, the preferred linking groups and the like in the following formulae are as follows.

### L¹¹

L¹¹ in Formula (A01), (A11), or (A1) (hereinafter, also referred to as Formula (A1) or the like) is preferably *—CO-L¹³-** or *-L¹³-CO—**. * represents a bonding part on the fused-ring structure (mother nucleus) side in each formula. ** represents the opposite bonding part (a bonding part to the constituent derived from the polyol compound).

### L¹³

L¹³ represents a single bond or a linking group, and specifically, is preferably an alkylene group, an alkenylene group, an alkynylene group, an arylene group, an oxygen atom, a carbonyl group, or a single bond, or a group formed in combination thereof. The number of linking groups to be combined in a combined group is not particularly limited, but is preferably 2 to 4.

Each of the alkylene group, the alkenylene group, and the alkynylene group, which can be adopted as L¹³, may be linear or branched, or may be cyclic. L¹³ is preferably an alkylene group having 2 to 10 carbon atoms, an alkenylene group having 2 to 10 carbon atoms, an arylene group having 6 to 18 carbon atoms, an oxygen atom, a carbonyl group, or a single bond, or a group formed in combination thereof. A chain-like alkylene group having 2 to 4 carbon atoms or a group formed in combination of the chain-like alkylene group with a carbonyl group; a cyclic alkylene group having 5 or 6 carbon atoms or a group formed in combination of the cyclic alkylene group with a carbonyl group; a chain-like alkenylene group having 2 to 4 carbon atoms or a group formed in combination of the chain-like alkenylene group with a carbonyl group; a cyclic alkenylene group having 5 or 6 carbon atoms, or a group formed in combination of the cyclic alkenylene group with a carbonyl group; an arylene group having 6 to 10 carbon atoms or a group formed in combination of the arylene group with a carbonyl group; an oxygen atom; or a single bond is more preferred.

Specific examples of the linking group, which can be adopted as L¹³, include the following groups, but the present invention is not construed as being limited thereto. In the following exemplified linking groups, * means a bonding part bonded to a fused-ring structure in each formula, and ** means a bonding part on the opposite side thereto.

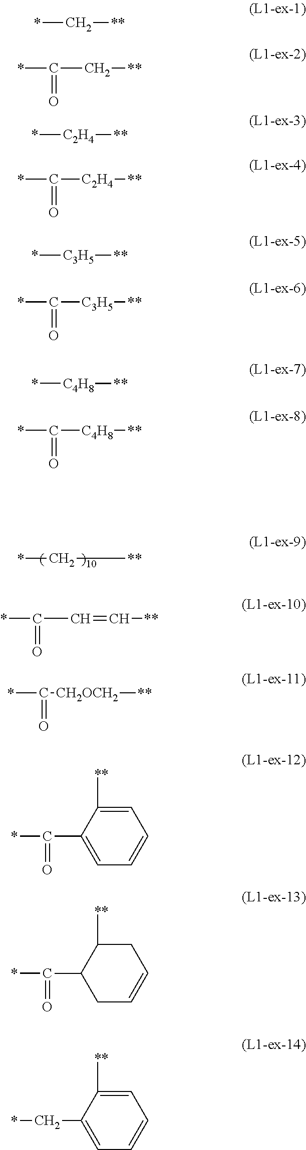

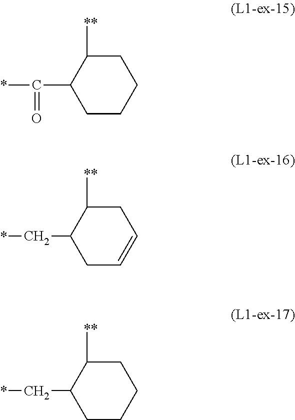

It is still more preferable that L¹³ in Formula (A1) or the like is a single bond, or a linking group (L1-ex-4), (L1-ex-11), or (L1-ex-12), and a single bond is particularly preferred. It is most preferable that L¹¹ is *—CO—**, *—COO—**, or *—CO-Rd-COO—** (Rd represents an alkylene group having 1 to 6 carbon atoms). * and ** are as described above.

In Formula (A1) or the like, the linking group L¹¹ may be bonded to any carbon atom at the 1-position to 4-position of the benzene ring in each formula, and the linking group L¹¹ is preferably bonded to any carbon atom represented at the 2-position or 4-position and is more preferably bonded to any carbon atom represented at the 2-position. This bonding position is similarly applied to (2) Polyester Polymer [II] and (3) Polyamide Polymer described later. In the position number of a carbon atom in the above-described formula, the 1-position corresponds to the 11-position, the 2-position corresponds to the 12-position, the 3-position corresponds to the 13-position, and the 4-position corresponds to the 14-position with respect to the position number of abietane.

### L¹²

L¹² is preferably a carbonyl group.

Another suitable aspect of the polyester polymer [I] includes a dimer structure in which two dehydroabietane main skeletons are bonded directly or through a linking group as a part of the molecular chains constituting the main chain. The constituent containing this dimer structure is represented by, for example, Formula (A02), (A12), or (A2) described above (hereinafter, also referred to as Formula (A2) or the like).

L²¹ and L²²

Each of L²¹ and L²² in Formula (A2) or the like is preferably a carbonyl group. Similarly to the above-described L¹², this means that the polymer according to the embodiment of the present embodiment has the constituent containing the DAA skeleton.

### L²³

L²³ is preferably an oxygen atom, a sulfur atom, a carbonyl group, a sulfonyl group, an alkylene group, an alkenylene group, an arylene group, or a single bond, or a group formed in combination thereof. The number of linking groups to be combined in a combined group is not particularly limited, but is preferably 2 to 4. Each of the alkylene group and the alkenylene group, which can be adopted as L²³, may be linear or branched, or may be cyclic. The linking group represented by L²³ is preferably formed of at least one selected from the group consisting of a single bond, an oxygen atom, a sulfur atom, a carbonyl group, a sulfonyl group, an alkylene group having 1 to 10 carbon atoms, an alkenylene group having 2 to 10 carbon atoms, and an arylene group having 6 to 18 carbon atoms, and more preferably a linking group formed of at least one selected from the group consisting of an oxygen atom, a sulfur atom, a carbonyl group, a sulfonyl group, a chain-like alkylene group having 1 to 4 carbon atoms, a cyclic alkylene group having 5 to 6 carbon atoms, a chain-like alkenylene group having 2 to 4 carbon atoms, a cyclic alkenylene group having 5 to 6 carbon atoms, an arylene group having 6 to 8 carbon atoms, or a single bond.

Each of an alkylene group, an alkenylene group, and an arylene group, which constitutes the linking group represented by L²³, may have a substituent. Examples of a substituent in an alkylene group, an alkenylene group, and an arylene group can include a substituent T described later. Specific examples of the linking group represented by L²³ include the following linking groups, but the present invention is not limited thereto.

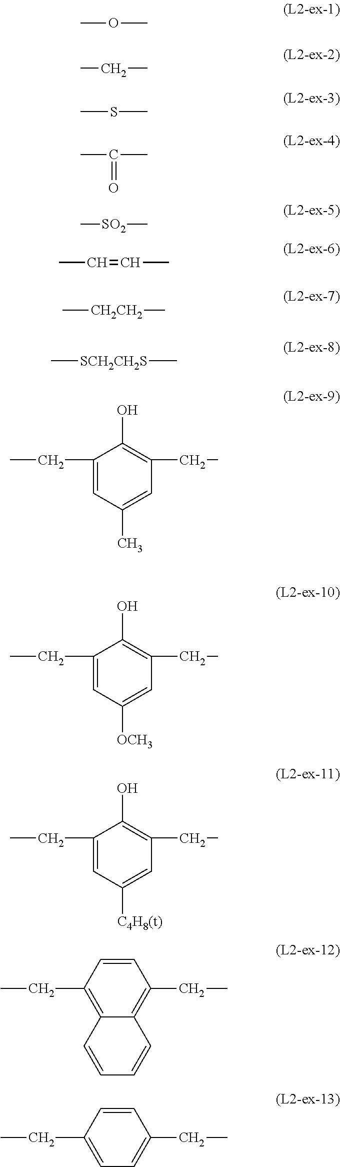

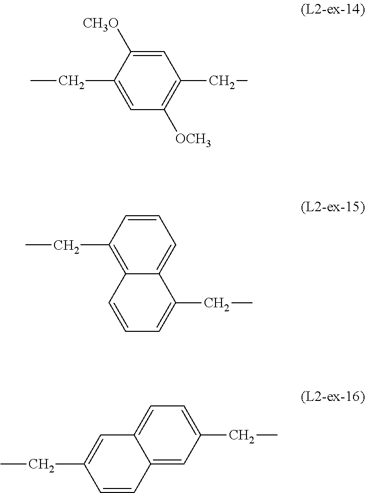

L²³ is preferably a linking group (L2-ex-2), (L2-ex-5), (L2-ex-9), or (L2-ex-11), and the linking group (L2-ex-2) is more preferred.

In Formula (A2) or the like, the linking group L²³ may be bonded to any carbon atom at the 1-position, 2-position, 4-position, 1′-position, 2′-position, or 4′-position of the benzene ring in each formula, and the linking group L²³ is preferably bonded to any carbon atom at the 2-position, 4-position, 2′-position, or 4′-position (where, in a combination of two benzene rings linked) and is more preferably bonded to any carbon atom at the 2-position or 2′-position. This bonding position is similarly applied to (2) Polyester Polymer [II] and (3) Polyamide Polymer described later.

The polyester polymer [I] may be a copolymer with another polycarboxylic acid compound. As the other polycarboxylic acid compound, a polycarboxylic acid compound generally used for forming a polyester polymer can be used without particular limitation, and for example, polycarboxylic acid compounds described in Synthetic Polymer V (Asakura Publishing Co., Ltd.), p. 63-91 and the like can be used.

Examples of the other polycarboxylic acid compounds include aromatic dicarboxylic acids such as terephthalic acid, isophthalic acid, and naphthalenedicarboxylic acid, and aliphatic dicarboxylic acids such as cyclohexane dicarboxylic acid, dicyclohexane dicarboxylic acid, and adipic acid. A content of a constituent derived from the other polycarboxylic acid compound in the polyester polymer [I] is not particularly limited to the extent that the effect of the present invention is not impaired. For example, the content of the constituent derived from the other polycarboxylic acid compound is preferably 40% by mole or less and more preferably 30% by mole or less in the constituent derived from the polycarboxylic acid compound for forming the polyester polymer [I].

The total content of a repeating unit containing the constituent having the DHA main skeleton or the dimer skeleton thereof (for example, the constituent represented by Formula (A1) and the constituent represented by Formula (A2)) in the repeating units containing the constituent derived from the polycarboxylic acid compound for forming the polyester polymer [I] is not particularly limited, but is preferably 10% by mole or more, more preferably 15% by mole or more, and still more preferably 20% by mole or more in a case where the sum of all repeating units is 100% by mole. The content of a constituent derived from a polycarboxylic acid in the polyester is generally 50% by mole, which is typically the upper limit.

### (Constituent Derived From Polyol Compound)

As the polyol compound from which a constituent constituting the polyester polymer [I] is derived, a polyol compound that is generally used for a polyester polymer can be used without particular limitation, and examples thereof include a polyol compound containing a ring structure, a polyol compound including no ring structure, and other polyol compounds. This polyol compound is not particularly limited, and a diol compound is preferred.

The polyester polymer [I] preferably contains a constituent represented by Formula (II-1) as the constituent derived from the polyol compound.

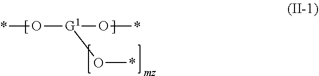

In Formula (II-1), G¹ represents an alkane linking group (alkanediyl, alkanetriyl, alkanetetrayl, or the like), an alkene linking group (alkenediyl, alkenetriyl, alkenetetrayl, or the like), an aryl linking group (aryldiyl, aryltriyl, aryltetrayl, or the like), or a heteroaryl linking group (heteroaryldiyl, heteroaryltriyl, heteroaryltetrayl, or the like), or a linking group formed in combination thereof. The linking group formed in combination is preferably a combination of an alkane linking group and an aryl linking group, a combination of aryl linking groups, or the like, and the number of linking groups to be combined is not particularly limited, but is preferably 2 to 4. The linking group in combination may further contain a group represented by L³ described later. G¹ is preferably an aryl linking group having the total number of carbon atoms of 6 to 24, to which a plurality of aryl linking groups may be linked, and is more preferably a linking group having a constituent derived from a polyol compound represented by Formula (B1) described later, with removal of an oxygen atom from both ends thereof.

In a case where G¹ is an alkane linking group or an alkene linking group, G¹ may be chain-like or cyclic, and in a case of being chain-like, G¹ may be linear or branched. One or more hydrogen atoms in the alkane linking group, the alkene linking group, the aryl linking group, or the heteroaryl linking group may be substituted with a specific substituent or may be unsubstituted. Examples of a substituent in a case of being substituted include a substituent T described later, and among these, an alkyl group and an alkenyl group are preferred. In addition, one or more carbon atoms constituting the alkane linking group and the alkene linking group may be substituted with a hetero-linking group, and examples of a hetero-linking group in a case of being substituted include an oxygen atom, an imino group, a sulfur atom, a carbonyl group. Among these, an oxygen atom is preferable (typically, a form in which a part of the alkylene chain is substituted and linked to an ether bond). In a case where a substituent is contained, the number of carbon atoms means that the number of carbon atoms contained in a substituent is excluded.

In a case where G¹ is an alkane linking group (preferably an alkylene group) or an alkene linking group (preferably an alkenylene group), the number of carbon atoms is preferably 2 to 30 and more preferably 2 to 20. The alkylene group and the alkenylene group each may be substituted or unsubstituted, and as described above, a part thereof may be substituted with a heteroatom. Furthermore, specifically, —(CH₂)₄—, —(CH₂)₅—, —(CH₂)₈—, —(CH₂)₁₀—, —(C(Ra)₂)—, —(CHRa)CH₂—, —(C(Rb))—, —CH₂—Rb—CH₂—, —(CH₂CH₂O)₂—CH₂CH₂—, and —(CH₂CH₂O)₃—CH₂CH₂— are more preferred. Ra is preferably an alkyl group or alkenyl group having 6 to 18 carbon atoms, and more preferably C₁₈H₃₇, C₁₆H₃₃, C₁₂H₂₅, C₈H₁₇, C₁₈H₃₅, C₁₆H₃₁, C₁₂H₂₃, or C₈H₁₅. Rb is preferably a cycloalkylene group having 4 to 12 carbon atoms, and more preferably a cyclohexanediyl group.

mz is an integer of 0 to 3.

### Constituent Derived From Polyol Compound Containing Ring Structure

The polyester polymer [I] preferably contains, as the constituent derived from the polyol compound, at least one constituent derived from a polyol compound having a ring structure. The ring structure contained in the polyol compound may be contained in a side chain moiety of the polyester polymer [I] or may be contained to form a part of the molecular chain constituting the main chain, but the ring structure contained in the polyol compound preferably forms a part of the molecular chain constituting the main chain.

The ring structure contained in the polyol compound may be an aliphatic ring or an aromatic ring, and may be a hydrocarbon ring or a hetero ring. Furthermore, the aliphatic ring may contain an unsaturated bond. In addition, the number of rings contained in the polyol compound is not particularly limited, and can be set to, for example, 1 to 5, and is preferably 1 to 3 and more preferably 1 or 2. In a case where the polyol compound contains two or more ring structures, the polyol compound may have a structure in which two or more monocycles are bonded by a covalent bond or a linking group, or may have a fused-ring structure.

Specific examples of the constituent derived from the polyol compound having a ring structure can include a constituent derived from cyclohexanediol, cyclohexanedimethanol, 1,4-bis(2-hydroxyethoxy)benzene, 1,4-bis(2-hydroxypropoxy)benzene, 4-hydroxyethylphenol, a diol compound used in Examples, or the like, and a constituent derived from a polyol compound represented by Formula (B1). The constituent derived from the polyol compound having a ring structure is preferably a constituent derived from the polyol compound represented by Formula (B1).

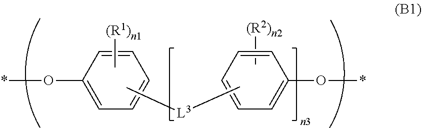

In Formula (B1), L³ represents an oxygen atom, a carbonyl group, a sulfonyl group, an alkylene group, a single bond, or a group formed in combination thereof. In a case where a plurality of L³'s are present, L³'s may be the same or different from each other. R¹ and R² each independently represent a substituent selected from the group consisting of a halogen atom, an alkyl group, and an alkoxy group, and may be bonded to each other to form a ring. In a case where a plurality of R¹'s and R²'s are also present, R¹'s may be the same or different from each other, and R²'s may be the same or different from each other. n1 and n2 each independently represent an integer of 0 to 4, and n3 represents an integer of 0 to 2. * represents a bonding part.

The alkylene group constituting the linking group of L³ may be a linear or branched chain-like alkylene group or a cyclic alkylene group. In addition, the number of carbon atoms in the alkylene group is preferably 1 to 6, and more preferably 1 to 4. The number of carbon atoms in the alkylene group referred to herein does not include the number of carbon atoms of substituents described later. Furthermore, the alkylene group may have a substituent such as a chain-like or cyclic alkyl group having 1 to 6 carbon atoms or an aryl group having 6 to 18 carbon atoms. The number of substituents in the alkylene group may be 2 or more, and in a case where the alkylene group has two or more substituents, the two or more substituents may be the same as or different from each other, and bonded to each other to form a ring.

In a case where L³ is a group formed in combination, the number of linking groups to be combined is not particularly limited, but is preferably 2 to 4.

R¹ and R² each independently represent a substituent selected from the group consisting of a halogen atom, an alkyl group, and an alkoxy group, and the substituent is preferably a substituent selected from the group consisting of a fluorine atom, a chlorine atom, an alkyl group having 1 to 8 carbon atoms, and an alkoxy group having 1 to 8 carbon atoms.

n1 and n2 each are preferably an integer of 0 to 2, more preferably 0 or 1, and still more preferably 0. n3 is preferably 0 or 1.

Specific examples of a constituent represented by Formula (B1) are shown below, but the present invention is not limited thereto.

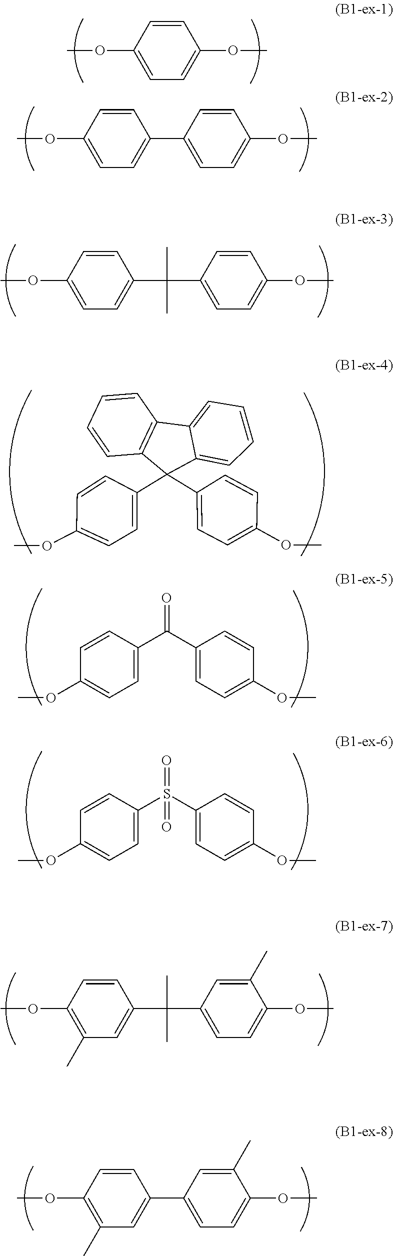

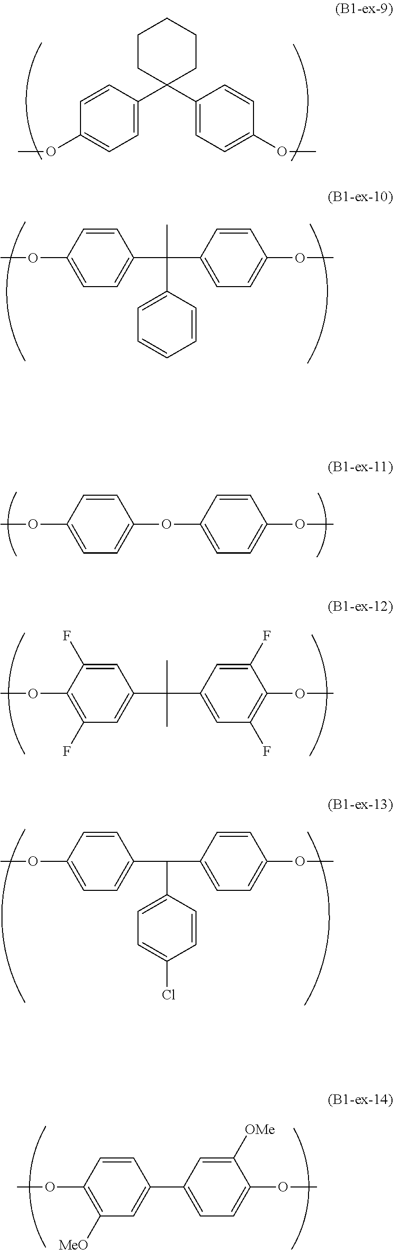

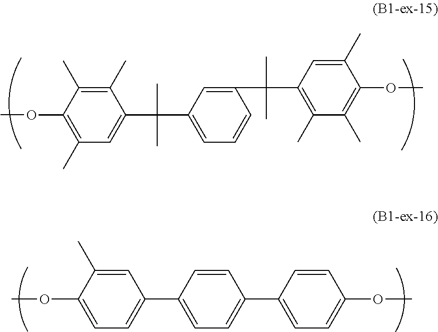

Examples of the constituent represented by Formula (B1) preferably include constituents (B1-ex-1), (B1-ex-2), (B1-ex-3), (B1-ex-4), (B1-ex-5), (B1-ex-6), (B1-ex-7), (B1-ex-9), (B1-ex-11) described above, or a constituent derived from a diol compound (b-5), (b-6), or (b-9) used in Examples.

The content of a repeating unit containing a constituent having a ring structure (for example, a constituent represented by Formula (B1)) in the repeating units containing the constituent derived from the polyol compound for forming the polyester polymer [I] is not particularly limited, but is preferably 10% by mole or more, more preferably 20% by mole or more, still more preferably 30% by mole or more, and particularly preferably 40% by mole or more. The content of the constituent derived from polyol in the polyester is generally 50% by mole, which is typically the upper limit.

### Constituent Derived From Polyol Compound Containing No Ring Structure

The polyester polymer [I] preferably contains, as the constituent derived from the polyol compound, at least one constituent derived from another polyol compound having no ring structure. As the polyol compound contains no ring structure, a polyol compound that is generally used for forming the polyester polymer [I] can be used without particular limitation, and examples thereof include a constituent containing no ring structure, among the constituents represented by Formula (II-1) described above. More specific examples thereof include diol compounds such as ethylene glycol, 1,2-propanediol, 1,3-propanediol, 1,4-butanediol, 1,6-hexanediol, 1,8-octanediol, 1,10-decanediol, 1,12-dodecanediol, diethylene glycol, triethylene glycol, and tetraethylene glycol.

A content of a repeating unit containing the constituent derived from the polyol compound containing no ring structure in the polyester polymer [I] is the same as those of the above-described ring structure in the preferred range thereof.

The constituent derived from the polyol compound, which the polyester polymer [I] has, may be used alone, or two or more kinds thereof may be used. In a case where the polyester polymer [I] has two or more constituents derived from a polyol compound, a content ratio thereof is appropriately selected depending on the intended purpose.

It is preferable that the polyester polymer [I] relates to a combination with at least one of the following structures as the constituent derived from the polycarboxylic acid compound.

### Constituent Derived From Polycarboxylic Acid Compound

Formula (A1) . . . L¹³ is a single bond, the constituent (L1-ex-4), (L1-ex-10), or (L1-ex-12), L¹² is a carbonyl group
Formula (A2) . . . L²³ is a linking group (L2-ex-2), (L2-ex-5), (L2-ex-9), or (L2-ex-11), and L²¹ and L²² each are a carbonyl group

### Constituent Derived From Polyol Compound

Constituents (B1-ex-1), (B1-ex-2), (B1-ex-3), (B1-ex-4), (B1-ex-5), (B1-ex-6), (B1-ex-7), (B1-ex-9), or (B1-ex-11), or a constituent derived from a diol compound (b-5), (b-6), or (b-9) used in Examples.

The following is more preferable.

### Constituent Derived From Polycarboxylic Acid Compound

Formula (A1) L¹¹ and L¹² each are a carbonyl group
Formula (A2) L²³ is (L2-ex-2), L²¹ and L²² each are a carbonyl group

### Constituent Derived From Polyol Compound

Constituents (B1-ex-1), (B1-ex-2), (B1-ex-3), (B1-ex-4), (B1-ex-6), or a constituent derived from a diol compound (b-5), (b-6), or (b-9) used in Examples.

A content ratio (molar ratio) of the constituent derived from the polycarboxylic acid compound to the constituent derived from the polyol compound, which constitutes the polyester polymer [I], is not particularly limited, but is usually 1:1.

The polyester polymer [I] can be produced by, for example, appropriately referring to “a method of producing a polyester polymer” described in JP5714442B, “a method of producing a polyester polymer [I]” described in JP2014-017464A, and furthermore, a synthesis method described in Examples below. Regarding a method of producing a polyester polymer, the above-described content of JP5714442B and the above-described content of JP2014-017464A are incorporated as part of the description of the present specification as they are.

### (2) Polyester Polymer [II]

A polyester polymer [II] preferably has at least one of the constituent represented by Formula (A1) or the like or the constituent represented by Formula (A2) or the like, as a constituent derived from a polyol compound, and has a repeating unit consisting of a constituent derived from a polycarboxylic acid compound.

(Constituent Derived from Polyol Compound)

The polyol compound from which this constituent is derived is not particularly limited, and a diol compound is preferred.

In the polyester polymer [II], in a case where at least one of the constituent represented by Formula (A1) or the like and the constituent represented by Formula (A2) or the like is a constituent derived from a polyol compound, the preferred linking groups and the like in the following formulae are as follows.

In the present embodiment, it is preferable that each of the linking groups is as follows.

### L¹¹

L¹¹ is *-L^{1A}O—**. * represents a bonding part on the fused ring side in each formula, and ** represents a bonding part on the opposite side thereto. A single bond or a divalent linking group represented by L^{1A} is not particularly limited, and examples thereof include —(CₙH₂ₙ)— and —CO(CₙH₂ₙ)—. Here, n is an integer of 1 to 12, preferably an integer of 1 to 8, may be linear, branched, or cyclic, and may further have a substituent. In addition, a structure in which one or more carbon atoms constituting a molecular chain are substituted with an oxygen atom may be employed.

L¹², L²¹, L²²

L¹², L²¹, and L²² each are *—CH₂—O—**. * represents a bonding part on the fused ring side in each formula, and ** represents a bonding part on the opposite side thereto.

### L²³

L²³ has the same meaning as (1) Polyester polymer [I], and the preferred range is also the same.

### (Constituent Derived From Polycarboxylic Acid Compound)

The polycarboxylic acid compound from which this constituent is derived is not particularly limited, and a dicarboxylic acid compound is preferred. The polycarboxylic acid compound is not particularly limited, and examples thereof include another polycarboxylic acid compound in the polyester polymer [I].

The polyester polymer [II] can be produced by, for example, referring to “a method of producing a polyester polymer [II]” described in JP2014-017464A, and the content of which is incorporated as a part of the description of the present specification as it is.

### (3) Polyamide Polymer

A polyamide polymer preferably has at least one of the constituent represented by Formula (A1) or the like or the constituent represented by Formula (A2) or the like, as a constituent derived from a polycarboxylic acid compound, and has a repeating unit consisting of a constituent derived from a polyamine compound.

(Constituent Derived from Polycarboxylic Acid Compound)

The polycarboxylic acid compound from which this constituent is derived is not particularly limited, and a dicarboxylic acid compound is preferred.

In the polyamide polymer, in a case where at least one of the constituent represented by Formula (A1) or the like and the constituent represented by Formula (A2) or the like is a constituent derived from a polycarboxylic acid compound, the preferred linking groups and the like in the following formulae are as follows.

### L¹¹

L¹¹ has the same meaning as L¹¹ in (1) Polyester polymer [I] described above, and the preferred range is also the same. Here, the linking group described as a linking group (L¹-ex-n) is preferably a single bond, or a linking group (L1-ex-4), (L1-ex-10), or (L1-ex-12), and more preferably a single bond.

L¹², L²¹, L²², L²³

L¹², L²¹, L²², and L²³ each have the same meaning as L¹², L²¹, L²², and L²³ in (1) Polyester polymer [I] described above, and the preferred ranges are also the same.

The total content of a repeating unit containing the constituent having the DHA main skeleton or the dimer skeleton thereof (for example, the constituent represented by Formula (A1), the constituent represented by Formula (A2), and a constituent represented by Formula (A3)) in the repeating units containing the constituent derived from the polycarboxylic acid compound for forming the polyamide polymer is not particularly limited, but is preferably 10% by mole or more, more preferably 15% by mole or more, and still more preferably 20% by mole or more, with respect to the total amount of the repeating units (for example, the total amount of the constituent derived from the polycarboxylic acid compound and the constituent derived from the polyamine compound). The upper limit is not particularly limited, but is practically 75% by mole or less and preferably 50% by mole or less.

The polyamide polymer contains at least one constituent derived from a polycarboxylic acid compound containing a DHA main skeleton or a dimer skeleton thereof, and as necessary, may contain at least one constituent derived from another polycarboxylic acid compound that does not contain a skeleton derived from a dehydroabietic acid compound.

As the other polycarboxylic acid compound, a polycarboxylic acid compound generally used for forming a polyamide polymer can be used without particular limitation, and for example, polycarboxylic acid compounds described in Synthetic Polymer V (Asakura Publishing Co., Ltd.), p. 63-91 and the like can be used. Examples of the other polycarboxylic acid compounds include aromatic dicarboxylic acids such as phthalic acid, terephthalic acid, isophthalic acid, and naphthalenedicarboxylic acid, and aliphatic dicarboxylic acids such as cyclohexane dicarboxylic acid, dicyclohexane dicarboxylic acid, succinic acid, adipic acid, sebacic acid, brassylic acid, maleic acid, and fumaric acid.

A content of a constituent derived from the other polycarboxylic acid compound in the polyamide polymer is not particularly limited to the extent that the effect of the present invention is not impaired. For example, the content of the constituent derived from the other polycarboxylic acid compound is preferably 40% by mole or less and more preferably 30% by mole or less in the constituent derived from the polycarboxylic acid compound for forming the polyamide polymer.

### (Constituent Derived From Polyamine Compound)

As the polyamine compound from which the constituent constituting the polyamide polymer is derived, a polyamine compound generally used for forming a polyamide polymer can be used without particular limitation, and examples thereof include polyamine compounds described in Polymer Data Handbook Fundamentals (edited by Polymer Society of Japan) (BAIFUKAN CO., LTD.), P. 241-257, and the like. This polyamine compound is not particularly limited, and a diamine compound is preferred.

The polyamide polymer preferably contains a constituent represented by Formula (II-2A) or (II-2B) described below as a constituent derived from a polyamine compound.

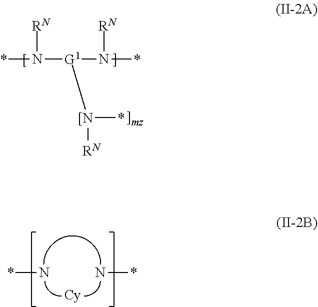

In Formula (II-2A), G¹ and mz each have the same meaning as G¹ and m in Formula (II-1). R^{N} represents a hydrogen atom or a substituent. A substituent, which can be adopted as R^{N}, is not particularly limited and is appropriately selected from a substituent T described later. The alkyl group is preferable. A plurality of R^{N}'s may be the same as or different from each other. The constituent represented by Formula (II-2A) in which R^{N} is a substituent is a constituent derived from a diamine compound having a secondary amino group (—NH-group).

In Formula (II-2B), Cy represents a nitrogen-containing ring (heterocyclic structure) containing two nitrogen atoms. The constituent represented by Formula (II-2B) is a constituent derived from a diamine compound having a secondary amino group (—NH— group) and also a constituent derived from a diamine compound having a heterocyclic structure containing two nitrogen atoms as heteroatoms. The nitrogen-containing ring which can be adopted as Cy may be an aliphatic ring or an aromatic ring, and may be a monocycle or a fused polycycle. Cy may contain a heteroatom other than the nitrogen atom, for example, an oxygen atom or a sulfur atom, as a ring-constituting atom. The number of ring-constituting atoms (excluding the hydrogen atoms) constituting Cy is not particularly limited, and for example, preferably 5 to 24 and more preferably 6 to 18 in terms of the total number with addition of two nitrogen atoms. In the present invention, the nitrogen-containing ring, which can be adopted as Cy, is preferably an aliphatic monocyclic ring. Examples of a monocyclic nitrogen-containing ring, which can be adopted as Cy, include an aliphatic nitrogen-containing ring such as imidazolidine, pyrazolidine, piperazine, or 1,4-diazacycloheptane. In addition, examples of a fused polycyclic nitrogen-containing ring, which can be adopted as Cy, include the above-described monocyclic nitrogen-containing ring and a nitrogen-containing ring having one nitrogen atom as a ring-constituting atom (for example, pyrrolidine, piperidine, or morpholine), and a fused polycyclic nitrogen-containing ring appropriately having a hydrocarbon ring. The nitrogen-containing ring, which can be adopted as Cy, is preferably imidazolidine, pyrazolidine, piperazine, diazacycloheptane, diazatetradecahydrophenanthrene, or the like. Examples of the diamine compound from which the constituent represented by Formula (II-2B) is derived include diamine compounds (c-6) to (c-10) used in Examples.

The constituent represented by Formula (II-2B), that is, Cy described above may have a substituent, and examples of the substituent include a substituent T described later, where an alkyl group is preferable.

The polyamine compound may be an aliphatic polyamine compound or an aromatic polyamine compound. In addition, the aliphatic polyamine compound may be chain-like or cyclic.

The aliphatic polyamine compound may be a chain-like polyaminoalkylene compound or a cyclic polyaminoalkylene compound, and may further include an unsaturated bond. Examples of the chain-like polyaminoalkylene compound include a compound from which a constituent represented by Formula (II-2A) described above (where, G¹ is an alkanediyl group) is derived, and examples of the cyclic polyaminoalkylene compound include a compound from which a constituent represented by Formula (II-2A) described above (where, G¹ is a cyclic alkane linking group) is derived. The number of carbon atoms in the polyaminoalkylene compound is not particularly limited, but, for example, preferably 2 to 20, more preferably 2 to 14, and still more preferably 2 to 10.

Examples of the aromatic polyamine compound can include a polyaminoarylene compound. Among these, a polyaminoarylene compound having 6 to 24 carbon atoms is preferred, a polyaminoarylene compound having 6 to 18 carbon atoms is more preferred, and a phenylenediamine compound is still more preferable.

In addition, the polyamine compound may be a polyamine compound formed of two kinds selected from a group derived from an aliphatic monoamino compound and a group derived from an aromatic monoamino compound, which are bonded via a divalent linking group. Examples of the divalent linking group can include a divalent linking group composed of at least one selected from the group consisting of an oxygen atom, a sulfur atom, a carbonyl group, a sulfonyl group, an alkylene group, an alkenylene group, and an arylene group. The number of kinds of a divalent linking group such as a group is selected from the above-described group is preferably 1 or 2, and the number of groups to be combined is not particularly limited, but preferably 2 to 4. An alkylene group and an alkenylene group constituting a divalent linking group each may be chain-like or cyclic. In a case where the alkylene group and the alkenylene group are chain-like, the number of carbon atoms therein is preferably 2 to 6. In addition, in a case where the alkylene group and the alkenylene group are cyclic, the number of carbon atoms is preferably 5 to 8. Two of a group derived from the aliphatic monoamino compound or a group derived from the aromatic monoamino compound, which constitutes the polyamine compound, may be bonded to each other to form a ring.

It is preferable that the polyamine compound contains a secondary amino group (—NH—) in a molecule, and examples thereof include a compound from which a constituent represented by Formula (II-2A) where RN is a substituent is derived, and more specifically, a N-substituted aliphatic polyamine compound and a N-substituted aromatic polyamine compound. In addition, the secondary amino group is preferably a group in which a nitrogen atom thereof is incorporated into a heterocyclic structure as a ring-constituting atom (a polyamine compound having a heterocyclic structure containing a nitrogen atom of a secondary amino group as a ring-constituting atom, for example, a compound from which a constituent represented by Formula (II-2B) is derived).

Furthermore, the polyamine compound preferably contains a heterocyclic structure, and examples thereof include a compound from which a constituent represented by Formula (II-2B) is derived.

The polyamine compound may have a substituent, and examples of the substituent include a substituent T described later, where an alkyl group is preferable.

Specific examples of the polyamine compound preferably used in the present invention will be shown below, but the present invention is not limited thereto.

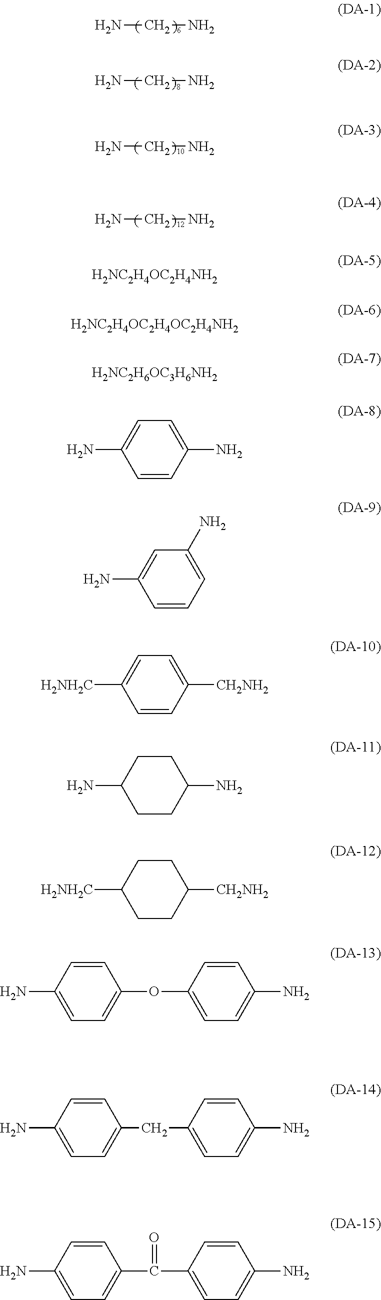

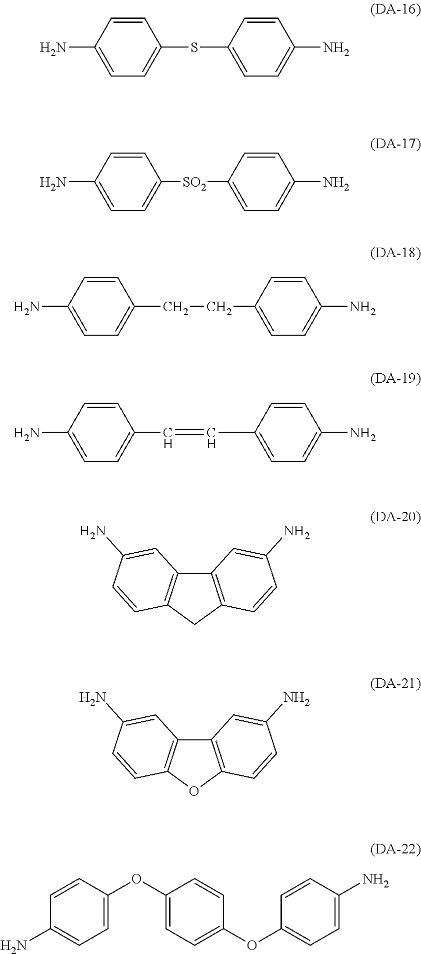

Regarding the polyamine compound, a polyamine compound formed of two or more kinds selected from a polyaminoalkylene compound having 2 to 14 carbon atoms, a polyaminoarylene compound having 6 to 24 carbon atoms, a group derived from an aliphatic monoamino compound, and a group derived from an aromatic monoamino compound, which are bonded via the above-described linking group, or a polyamine compound having a heterocyclic structure is preferred. Among these preferred polyamine compounds, a polyamine compound having a secondary amino group is more preferred.

A constituent that is contained in the polyamide polymer and derived from a polyamine compound may be used alone, or two or more kinds thereof may be used. In a case where the polyamide polymer has two or more constituents derived from a polyamine compound, a content ratio thereof is appropriately selected depending on the intended purpose.

A content ratio (molar ratio) of the constituent derived from the polycarboxylic acid compound to the constituent derived from the polyamine compound, which constitutes the polyamide polymer, is not particularly limited, but is usually 1:1.

The polyamide polymer can be synthesized by reacting a polycarboxylic acid compound from which a constituent consisting of the above-described DHA main skeleton or the dimer skeleton thereof is derived with a polyamine compound. Regarding this polymerization reaction, appropriately referring to a known reaction method, for example, a “method of producing a polyamide polymer” described in JP5734779B enables the production of the polyamide polymer. The above-described content of JP5734779B is incorporated as a part of the description of the present specification as it is.

In the above description, in terms of the adsorption characteristics, the polymer according to the embodiment of the present invention is preferably a polymer having a repeating unit consisting of a constituent containing, in a molecular chain constituting a main chain, a DHA main skeleton or a dimer skeleton thereof and a constituent derived from a polyamine compound containing a secondary amino group or a heterocyclic structure. Furthermore, the polymer is preferably a polymer having a repeating unit consisting of a constituent containing, in a molecular chain constituting a main chain, a DHA main skeleton or a dimer skeleton thereof and a constituent derived from a polyamine compound containing a secondary amino group or a heterocyclic polyamine compound.

The polyester polymer and the polyamide polymer are as described above, and the descriptions described in JP5395650B, JP5714442B, and JP5734779B can also be referred to, and the contents described in these documents are incorporated as part of the description of the present specification as they are.

### (Molecular Weight and the Like)

A weight-average molecular weight of the polymer according to the embodiment of the present invention is not particularly limited, and is appropriately determined according to the applicable form, the applicable use, and the like. For example, 1,000 or more is preferred, 2,000 or more is more preferred, and 3,000 or more is still more preferred. The upper limit of the weight-average molecular weight is not particularly limited, and for example, can be set to 1,000,000, 500,000, or can also be set to 300,000. The polymer according to the embodiment of the present invention may be a non-cross-linked polymer or a cross-linked polymer.

In the present invention, the weight-average molecular weight is a value obtained by measuring a molecular weight (in terms of polystyrene) by gel permeation chromatography (GPC). In the present invention, unless otherwise specified, the value is a value measured by using N-methyl-2-pyrrolidone (NMP) as a carrier, and “TSK-gel Super AWM-H” (product name) manufactured by TOSOH CORPORATION as a column.

Examples of the substituent T include the following:

The examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, such as vinyl, allyl, and oleyl), an alkynyl group (preferably an alkynyl group having 2 to 20 carbon atoms, for example, ethynyl, butadynyl, and phenylethynyl), a cycloalkyl group (preferably a cycloalkyl group having 3 to 20 carbon atoms, such as cyclopropyl, cyclopentyl, cyclohexyl, and 4-methylcyclohexyl; in the present invention, the alkyl group generally has meaning including a cycloalkyl group when being referred to; however, it will be described separately herein), an aryl group (preferably an aryl group having 6 to 26 carbon atoms, such as phenyl, 1-naphthyl, 4-methoxyphenyl, 2-chlorophenyl, and 3-methylphenyl), and a heterocyclic group (preferably a heterocyclic group having 2 to 20 carbon atoms and more preferably a 5- or 6-membered heterocyclic group having at least one oxygen atom, one sulfur atom, or one nitrogen atom. The heterocyclic group includes an aromatic heterocyclic group and an aliphatic heterocyclic group. Examples thereof include a tetrahydropyran ring group, a tetrahydrofuran ring group, 2-pyridyl, 4-pyridyl, 2-imidazolyl, 2-benzimidazolyl, 2-thiazolyl, 2-oxazolyl, pyrrolidone group or the like), an alkoxy group (preferably an alkoxy group having 1 to 20 carbon atoms, for example, methoxy, ethoxy, isopropyloxy, benzyloxy, or the like), an aryloxy group (preferably an aryloxy group having 6 to 26 carbon atoms, for example, phenoxy, 1-naphthyloxy, 3-methylphenoxy, 4-methoxyphenoxy, or the like), a heterocyclic oxy group (a group in which an —O— group is bonded to the above-described heterocyclic group), an alkoxycarbonyl group (preferably an alkoxycarbonyl group having 2 to 20 carbon atoms, for example, ethoxycarbonyl, 2-ethylhexyloxycarbonyl, dodecyloxycarbonyl, or the like), an aryloxycarbonyl group (preferably an aryloxycarbonyl group having 6 to 26 carbon atoms, for example, phenoxycarbonyl, 1-naphthyloxycarbonyl, 3-methylphenoxycarbonyl, 4-methoxyphenoxycarbonyl, or the like), a heterocyclic oxycarbonyl group (a group in which an —O—CO— group is bonded to the above-described heterocyclic group), an amino group (preferably an amino group having 0 to 20 carbon atoms, an alkylamino group, or an arylamino group, for example, amino, N,N-dimethylamino, N,N-diethylamino, N-ethylamino, anilino, or the like), a sulfamoyl group (preferably a sulfonamide group having 0 to 20 carbon atoms, for example, N,N-dimethylsulfamoyl N-phenylsufamoyl, or the like), an acyl group (an alkylcarbonyl group, an alkenylcarbonyl group, an alkynylcarbonyl group, an arylcarbonyl group, or a heterocyclic carbonyl group, preferably an acyl group having 1 to 20 carbon atoms, for example, acetyl, propionyl, butyryl, benzoyl, or the like), an acyloxy group (an alkylcarbonyloxy group, an alkenylcarbonyloxy group, an alkynylcarbonyloxy group, or a heterocyclic carbonyloxy group, preferably an acyloxy group having 1 to 20 carbon atoms, for example, acetyloxy or the like), an aryloyloxy group (preferably an aryloyloxy group having 7 to 23 carbon atoms, for example, benzoyloxy, naphthoyloxy, or the like), a carbamoyl group (preferably a carbamoyl group having 1 to 20 carbon atoms, for example, N,N-dimethylcarbamoyl, N-phenylcarbamoyl, or the like), an acylamino group (preferably an acylamino group having 1 to 20 carbon atoms, for example, acetylamino, benzoylamino, or the like), a sulfonamide group (preferably a sulfamoyl group having 0 to 20 carbon atoms, for example, methanesulfonamide, benzenesulfonamide, N-methylmethanesulfonamide, N-ethylbenzenesulfonamide, or the like), an alkylthio group (preferably an alkylthio group having 1 to 20 carbon atoms, for example, methylthio, ethylthio, isopropylthio, benzylthio, or the like), an arylthio group (preferably an arylthio group having 6 to 26 carbon atoms, for example, phenylthio, 1-naphthylthio, 3-methylphenylthio, 4-methoxyphenylthio, or the like), a heterocyclic thio group (a group in which an —S— group is bonded to the above-described heterocyclic group), an alkyl or arylsulfonyl group (preferably an alkyl or arylsulfonyl group having 1 to 20 carbon atoms, for example, methylsulfonyl, ethylsulfonyl, benzenesulfonyl, or the like), a hydroxyl group, a cyano group, a halogen atom (for example, a fluorine atom, a chlorine atom, a bromine atom, an iodine atom, or the like), more preferably an alkyl group, an alkenyl group, an aryl group, a heterocyclic group, an alkoxy group, an aryloxy group, an alkoxy carbonyl group, an amino group, an acylamino group, a hydroxyl group, or a halogen atom, and particularly preferably an alkyl group, an alkenyl group, a heterocyclic group, an alkoxy group, an alkoxy carbonyl group, an amino group, an acylamino group, or a hydroxyl group.

In addition, each group listed in these substituents T may be further substituted with any of the above-described substituents T.

In a case where the compound, substituent, linking group, and the like contain an alkyl group, an alkylene group, an alkenyl group, an alkenylene group, and the like, these groups may be cyclic or chain-like, may be linear or branched, and may be substituted or unsubstituted as described above. In addition, in a case where a compound or a substituent, a linking group, or the like contains an aryl group or a heterocyclic group, these groups may have a monocyclic or fused ring and may be substituted or unsubstituted as described above.

### Other Components

As the other components constituting the adsorbent of the present invention, various components generally used in combination with an adsorption component can be appropriately selected and used depending on the applicable form, the applicable use, or the like of the adsorbent according to an embodiment of the present invention.

In a case where the adsorbent according to the embodiment of the present invention contains other components, the polymer according to the embodiment of the present invention and other components can be mixed and composited by a common method to obtain an adsorbent.

### Method of Use

The adsorbent according to an embodiment of the present invention is used in the same manner as in a case of an adsorbent in the related art, for example, activated carbon or zeolite.

For example, the adsorbent according to the embodiment of the present invention can be used in a form of particles, a sheet, or the like, and a form in which an adsorbent is carried (fixed) on a support or the like. In a case where the adsorbent according to the embodiment of the present invention is used in the form of particles, a particle diameter thereof is not particularly limited and is set appropriately. The support is not particularly limited, and examples thereof include a commonly used inorganic support (for example, silica or various metals).

The adsorbent according to the embodiment of the present invention is preferably used as an adsorbent that adsorbs and removes organic substances as adsorbates (solutes) from aqueous liquid such as an aqueous solution and an aqueous dispersion liquid, which are liquids to be treated.

The aqueous liquid may be a liquid containing water and may further contain an aqueous organic solvent, an ionic liquid, and the like. Examples of the aqueous organic solvent include an organic solvent that is miscible with water, such as an alcohol compound (preferably an alcohol having 1 to 3 carbon atoms), acetonitrile, acetone, and tetrahydrofuran. A proportion of water in the aqueous liquid is not particularly limited and appropriately determined, and for example, the proportion is preferably 10% by mass or more, more preferably 50% by mass or more, and particularly preferably 80% by mass or more. As the ionic liquid, known ionic liquids can be used without particular limitation, and a content thereof is appropriately set.

In addition to an adsorbate, the liquid to be treated may contain a surfactant, or the like as a compound (also referred to as a non-adsorbate) other than the adsorbate, an inorganic salt, an organic salt, and a content of these components is appropriately determined to the extent that the effect of the present invention is not impaired (for example, to the extent that the adsorption of the adsorbate is not inhibited). In addition, the liquid to be treated may contain a plurality of organic substances, and examples thereof include an organic substance which is selectively adsorbed by the adsorbent according to the embodiment of the present invention, and an organic substance other than the organic substance which is selectively adsorbed by the adsorbent according to the embodiment of the present invention (in the present invention, also referred to as a non-selectively adsorbed organic substance, for convenience). In the present invention, the selectively adsorbed organic substance refers to an organic substance having a higher adsorption amount than another organic substance among the organic substances coexisting in the liquid to be treated, and specifically, refers to a compound that satisfies “high selectivity” described later. The selectively adsorbed organic substance is not limited to one kind, and two or more of a plurality of kinds may be employed depending on the number of coexisting organic substances. In addition, the non-selectively adsorbed organic substance is determined from the viewpoint of preferential adsorptive property (adsorption amount) with an organic substance selectively adsorbed by the adsorbent according to the embodiment of the present invention, and cannot be unambiguously determined because the non-selectively adsorbed organic substance varies depending on an organic substance selectively adsorbed by the adsorbent according to the embodiment of the present invention. The non-selectively adsorbed organic substance refers to a non-adsorbate that satisfies “high selectivity” described later, and encompasses a low adsorption organic substance which is not selectively or preferentially adsorbed by the adsorbent according to the embodiment of the present invention, in addition to an organic substance which is not adsorbed by the adsorbent according to the embodiment of the present invention. Examples of the non-selectively adsorbed organic substance include hydrophilic organic substances and organic substances such as pharmaceuticals exemplified below, and more specific examples thereof include organic substances having a dispersion coefficient or a molecular weight out of the following range. A content of a non-adsorbed organic substance is also appropriately determined to the extent that the effect of the present invention is not impaired.

One or two or more compounds other than the adsorbate contained in the liquid to be treated may be used.

The adsorbate is not particularly limited, but from the viewpoint of the adsorptive property, an organic substance is preferred. Examples thereof include pharmaceuticals, agricultural chemicals, insecticides, biomolecules, toxins, endocrine disruptors, additives for resins, pollutants, organic solvents, or metabolites or decomposition products thereof, and specific examples thereof include various biological toxins or hydrophobic organic solvents used in Examples. The adsorbate is preferably a hydrophobic organic substance. For example, focusing on the partition coefficient: clogD (a measuring method will be described later in Examples), the adsorbate is preferably an organic substance of −1 or more, more preferably an organic substance of more than 0, still more preferably an organic substance of 1 or more, and particularly preferably an organic substance of 1.3 or more. The upper limit value of ClogD is not particularly limited, but is preferably 6 or less from the viewpoint of the solubility of the solute. A molecular weight of the adsorbate is not particularly limited; however, in a case where the molecular weight of the adsorbate is too large, the adsorbate tends not to be easily adsorbed, and for example, the molecular weight of the adsorbate is preferably 2,000 or less, more preferably 600 or less, still more preferably 300 or less, and particularly preferably 250 or less. The lower limit thereof is not particularly limited, but for example, can be 50 or more. It is preferable that the adsorbate has clogD within the above range and a molecular weight in the above range together. A content of the adsorbate in the aqueous liquid is not particularly limited, but for example, preferably 10% by mass or less, and more preferably 2% by mass or less.

The adsorbent according to the embodiment of the present invention adsorbs an adsorbate by being brought into contact with the above-described aqueous liquid. The method of bringing the adsorbent into contact with the aqueous liquid is not particularly limited, and common methods and conditions are applied. Examples thereof include a method of injecting the adsorbent according to the embodiment of the present invention into an aqueous liquid and allowing the adsorbent to be left to stand or stirring the mixture, and a method of causing the aqueous liquid to flow through the adsorbent according to the embodiment of the present invention. The contact time (the flow time) is appropriately set to a time sufficient for the adsorbate to be adsorbed to the adsorbent. A contact temperature is not particularly limited.

The use amount of the adsorbent is set to an amount that allows the adsorbent to adsorb the adsorbate, and for example, the use amount can be 1 g or more and is preferably 5 g or more, with respect to 1 g of the adsorbate.

As described above, the adsorbent according to the embodiment of the present invention is brought into contact with an aqueous liquid containing an adsorbate to adsorb the adsorbate; thereby, the removal or separation of the adsorbate from the aqueous liquid can be achieved.

Although the details of the reason why the adsorbent according to the embodiment of the present invention can adsorb the adsorbate are not clear yet, it is conceived as follows. Since the polymer according to the embodiment of the present invention has the constituent containing a DHA main skeleton or a dimer skeleton thereof, the polymer exhibits hydrophobicity. It is conceived that in a case where this polymer is brought into contact with an adsorbate, selective and preferential adsorption between the polymer and the adsorbate occurs by a physical action, for example, an intermolecular force. In particular, in a case where an aqueous liquid containing a hydrophobic adsorbate is targeted for treatment, the polymer adsorbs the adsorbate, thereby reducing the interfacial energy between the polymer and the aqueous liquid and reducing the in-system energy, resulting in allowing the effective expression of this physical action. As a result, the adsorbent containing the polymer according to the embodiment of the present invention exhibits excellent adsorption characteristics with respect to the aqueous liquid containing a hydrophobic adsorbate. In particular, in a case where the liquid to be treated contains a compound other than the adsorbate, the adsorbent according to the embodiment of the present invention can adsorb the adsorbate with high selectivity, and the adsorbate can be separated and removed from the compound other than the adsorbate with high selectivity and high purity. In the present invention, the high selectivity means that the adsorption amount (mg/1 g) of the adsorbate is 3 times or more and preferably 10 times or more with respect to the adsorption amount (mg/1 g) of a non-adsorbate. Here, the adsorption amount (mg/1 g) refers to the adsorption amount per 1 g of the adsorbent according to the embodiment of the present invention (in a case where the adsorbent according to the embodiment of the present invention contains other components, the polymer according to the embodiment of the present invention, which is contained in the adsorbent according to the embodiment of the present invention), and the adsorption amount (mg/1 g) of the adsorbate cannot be unambiguously determined, but can be 10 mg/1 g or more, for example.

### Adsorption Apparatus

It is sufficient that an adsorption apparatus according to an embodiment of the present invention includes the adsorbent according to the embodiment of the present invention, and a configuration of a known adsorption apparatus can be applied.

Examples of the adsorption apparatus according to the embodiment of the present invention include an apparatus provided with an adsorption tube in which a column or a tube body is filled with the adsorbent according to the embodiment of the present invention as a stationary phase, which may be further provided with a transfer unit that transfers an aqueous liquid as a mobile phase under normal pressure or under pressure. Examples of such an adsorption apparatus include a liquid chromatography apparatus, a gas chromatography apparatus, a hemodialysis apparatus, a peritoneal dialyzer, and a dialyzer. The adsorption apparatus according to the embodiment of the present invention can adsorb an adsorbate and remove and separate the adsorbate from a liquid to be treated. Therefore, it can also be referred to as an adsorbate removal apparatus or an adsorbate separation apparatus.

In addition, the adsorption apparatus according to the embodiment of the present invention may be provided with an analysis unit that identifies and/or quantifies the adsorbate, and the like.

### Pharmaceutical Use

The adsorbent according to the embodiment of the present invention can be applied to the pharmaceutical use, and in this case, the present invention is a pharmaceutical composition containing an adsorbent that contains a polymer (hereinafter, simply referred to as a polymer A) containing, in a molecular chain constituting a main chain, a skeleton derived from a dehydroabietic acid compound, and is preferably a pharmaceutical composition for uremia. The pharmaceutical composition may contain other additives. The polymer A is the above-described polymer according to the embodiment of the present invention, and suitable examples thereof are also the same.

An object of the present invention is to further provide:
(A) the use of the polymer A (encompassing an aspect of an “adsorbent containing the polymer A”, the same applies to (B) to (D) below) for the production of a pharmaceutical composition;
(B) the polymer A for use in the treatment of a subject;
(C) a treatment method including administering an effective dose of the polymer A to the subject; and
(D) a method of administering a pharmaceutical composition to the subject, in which the pharmaceutical composition contains the polymer A.

The “subject” means a mammal such as a human, a mouse, a monkey, or a domestic animal requiring the prevention or therapy therefor, and is preferably means a human requiring the prevention or therapy.

The term “treatment” refers to prevention, therapy, or the like of a variety of diseases. The disease is preferably uremia.

The “prevention” refers to the inhibition of the onset of a disease, the reduction of the risk of the onset of a disease, or the delay of the onset of a disease.

The “therapy” refers to the improvement of or the suppression (maintenance or delay) or the like of the progression of target diseases or conditions.

### EXAMPLES

Hereinafter, the present invention will be described in more detail according to Examples, but the present invention is not limited and construed thereupon. “Parts” and “%” that represent compositions in the following examples are based on the mass unless otherwise specified. In the present invention, “room temperature” means 25° C.

### Synthesis Example M1

### Synthesis of 12-Carboxydehydroabietic Acid (a-1)

12-Carboxydehydroabietic acid (a-1) used for the synthesis of a polymer described later was synthesized according to the synthesis route shown in the following Scheme A.

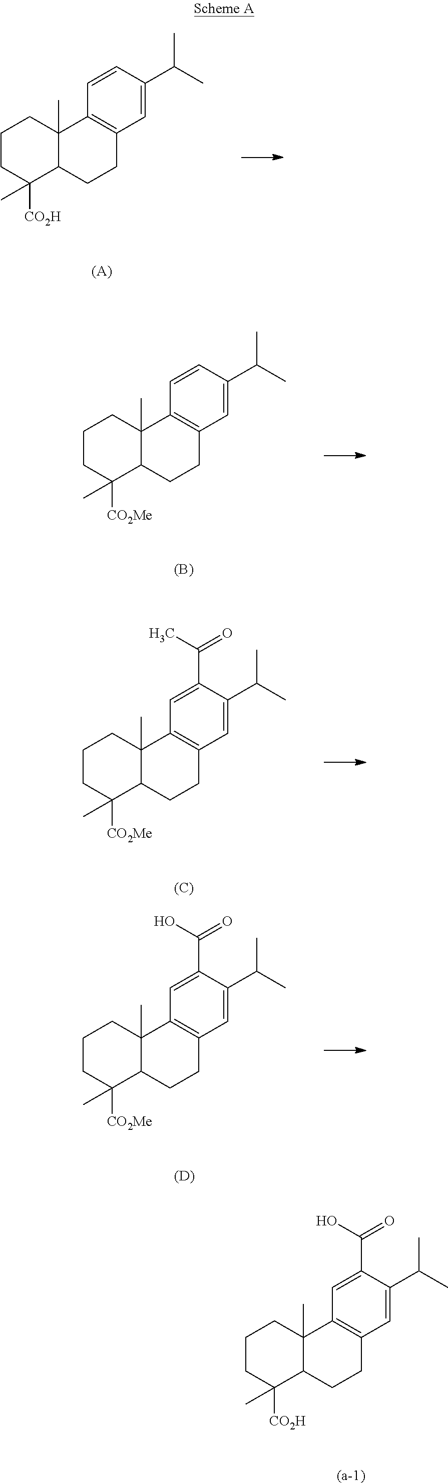

To a mixture of 60.0 g of dehydroabietic acid (A) (manufactured by Arakawa Chemical Industries, Ltd.) having a purity of 92% and 120 mL of methylene chloride was added dropwise 26.8 g of oxalyl chloride at room temperature. After stirring for 3 hours, the solvent was distilled off under reduced pressure, and 32.0 g of methanol was added dropwise thereto. After stirring at room temperature for 3 hours, excess methanol was distilled off under reduced pressure to obtain 62.8 g of white crystals of a compound (B).

To a mixture of 62.8 g of the compound (B), 18.8 g of acetyl chloride, and 160 mL of methylene chloride was added portionwise 58.6 g of anhydrous aluminum chloride at 3° C. to 5° C. After stirring at 5° C. to 8° C. for 2 hours, the reaction solution was poured into 1000 g of ice water. 400 mL of ethyl acetate was added to extract a reaction product into an organic layer. The organic layer separated from an aqueous layer was washed with a saline solution and dried over anhydrous magnesium chloride, and the solvent was distilled off under reduced pressure. 100 mL of cold methanol was added to the obtained residue, and precipitated white crystals of a compound (C) were collected by filtration (yield: 65.6 g).

64.0 g of sodium hydroxide was dissolved in 200 mL of water, and 51.2 g of bromine was added dropwise thereto at 8° C. to 10° C. A solution obtained by dissolving 35.6 g of the compound (C) in 200 mL of dimethoxyethane was added dropwise thereto at 10° C. to 12° C. The reaction solution was stirred at room temperature for 2 hours and poured into 6 N cold dilute hydrochloric acid to be acidic, and precipitated white crystals were collected by filtration. The obtained crystals were recrystallized from methanol to obtain 29.8 g of crystals of a compound (D).

To 20.4 g of the compound (D) was added 100 g of 10% by mass sodium hydroxide water, and the mixture was stirred. Then, the reaction system was heated at an external installation temperature of 130° C. and slowly refluxed. The mixture was stirred as it was for 3 hours, the reaction was checked by thin layer chromatography, and the temperature of the reaction system was then cooled to room temperature. The contents of the reaction system were slowly added to 250 mL of the cooled 1 N hydrochloric acid, and the resultant mixture was subjected to acid precipitation. The obtained precipitate was filtered by Nutche and washed with water until the filtrate was neutral. The obtained solid was taken out and dried to obtain 19.2 g of 12-carboxydehydroabietic acid (a-1).

<Identification on 12-Carboxydehydroabietic Acid (a-1)>

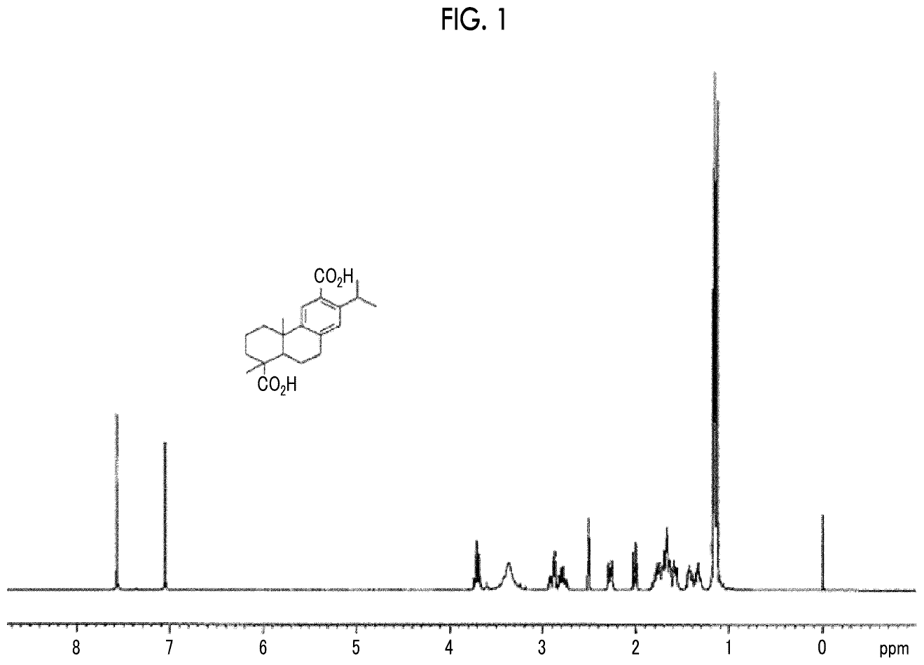

The synthesized 12-carboxydehydroabietic acid (a-1) was dissolved in dimethyl sulfoxide-d6 (deuterated DMSO) to measure ¹H-NMR, and the identification is carried from the obtained chart (FIG. 1).

Nuclear magnetic resonance spectroscopy (NMR) device: Ascend-400 mHz (manufactured by Bruker Corporation)

Integration times: 16 times

### Synthesis Example M2

### Synthesis of 12-Carboxydehydroabietic Acid Chloride (a-1C)

12-Carboxydehydroabietic acid chloride (a-1C) was synthesized according to the synthesis route shown in the following Scheme B.

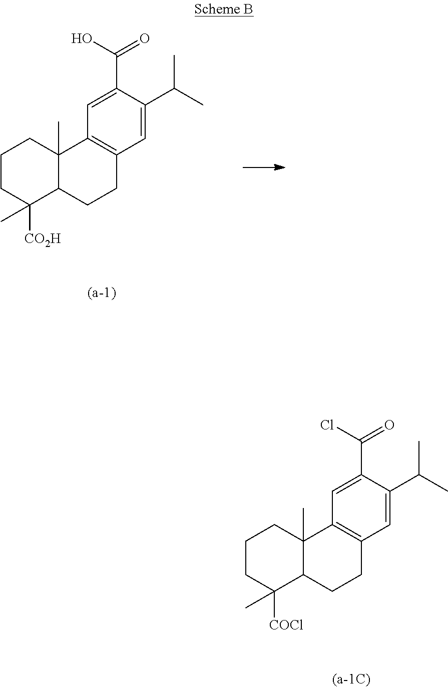 [SMILES: CC(C)c1cc2c(cc1C(=O)O)C1(C)CCCC(C)(C(=O)O)C1CC2 ; CC(C)c1cc2c(cc1C(=O)Cl)C1(C)CCCC(C)(C(=O)Cl)C1CC2]

13.76 g of crystals of 12-carboxydehydroabietic acid (a-1) was dispersed in 160 mL of methylene chloride, 11.18 g of oxalyl chloride, and 0.6 mL of dimethylformamide were added thereto, and the mixture was heated under reflux for 5 hours. During this period, the crystals were completely dissolved. After allowing to cool, the solvent was distilled off under reduced pressure, 20 mL of ethyl acetate and 60 mL of n-hexane were added to the residue, and a white precipitate of an acid chloride (a-1C) of 12-carboxydehydroabietic acid (a-1) was collected by filtration and dried under reduced pressure. The yield was 13 g.

<Identification on 12-Carboxydehydroabietic Acid Chloride (a-1C)>

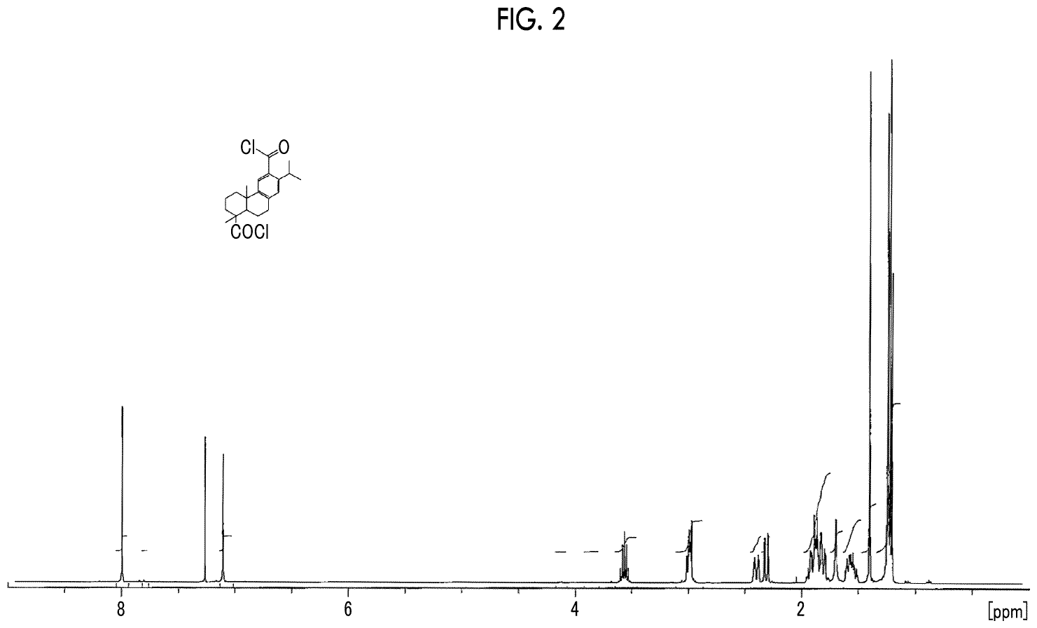

The synthesized 12-carboxydehydroabietic acid chloride (a-1C) was dissolved in deuterochloroform, ¹H-NMR was measured, and identification was carried out from the obtained chart (FIG. 2).

The NMR device and the number of integration times are as described above.

### Synthesis Example M3

### Synthesis of Dicarboxylic Acid (a-2)

Dicarboxylic acid (a-2) was synthesized according to the synthesis route shown in the following Scheme C.

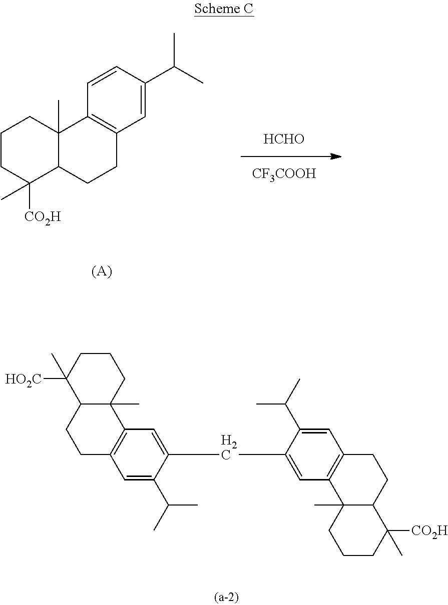 [SMILES: CC(C)c1ccc2c(c1)CCC1C(C)(C(=O)O)CCCC21C ; "CF3COOH" ; "HCHO" ; "(A)" ; CC(C)c1cc2c(cc1CCCc1cc3c(cc1C(C)C)CCC1C(C)(C(=O)O)CCCC31C)C1(C)CCCC(C)(C(=O)O)C1CC2]

To a mixture of 120 g of dehydroabietic acid (A) (manufactured by Arakawa Chemical Industries, Ltd.) having a purity of 92%, 20 mL of 36% formalin, and 200 mL of methylene chloride was added dropwise 200 mL of trifluoroacetic acid at 10° C. to 15° C. After stirring at 15° C. to 20° C. for 8 hours, methylene chloride and trifluoroacetic acid were distilled off under reduced pressure. 2 L of water was added to the residue, and off-white crystals were separated by filtration and thoroughly washed with water. After drying, 1 L of hot n-hexane was added thereto, the mixture was stirred for 1 hour and then allowed to cool, and white crystals of dicarboxylic acid (a-2) were collected by filtration. The yield was 118 g.

<Identification on Dicarboxylic Acid (a-2)>

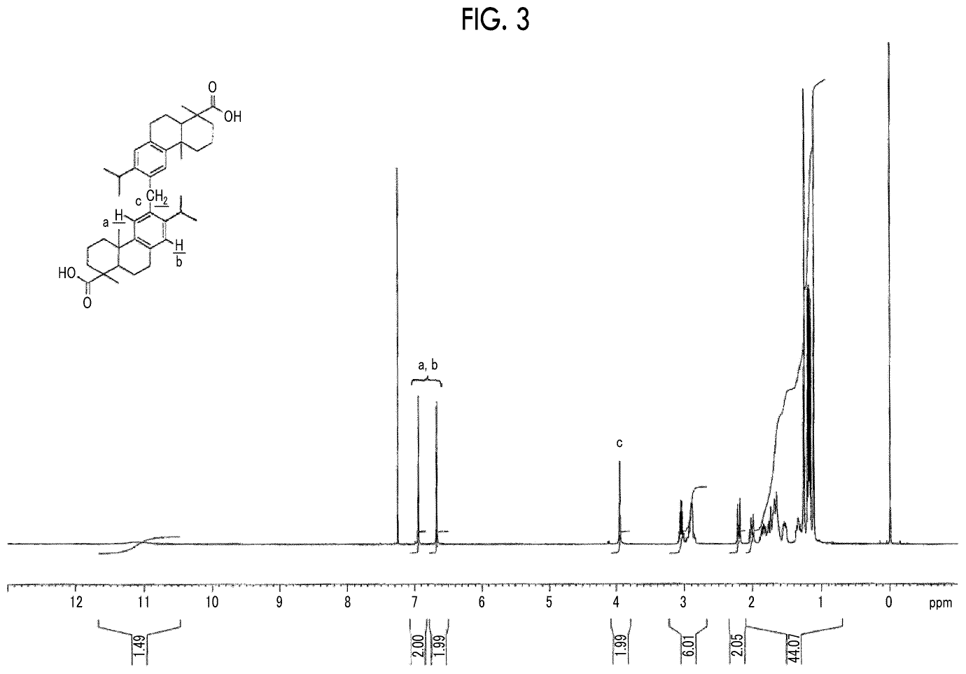

The synthesized dicarboxylic acid (a-2) was dissolved in deuterochloroform, ¹H-NMR was measured, and identification was carried out from the obtained chart (FIG. 3).

The NMR device and the number of integration times are as described above.

### Synthesis Example PE1

### Synthesis of Polyester Polymer PE-1

A polyester polymer PE-1 was synthesized according to the following scheme.

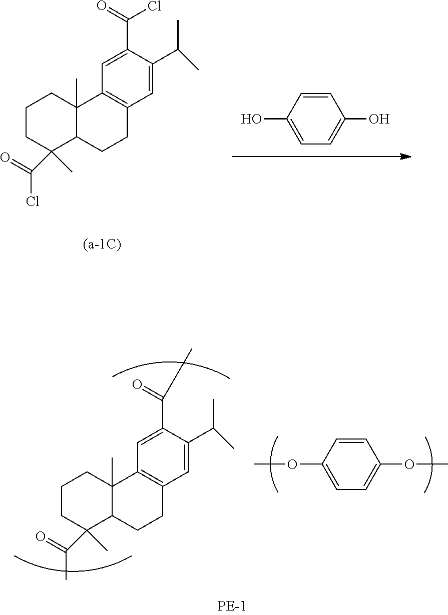

As a diol compound, 5.78 g of hydroquinone (b-1) and 13.5 g of N,N′-dimethylaminopyridine were dissolved in 150 mL of N-methylpyrrolidone (NMP). The internal temperature of the obtained solution was cooled to 10° C., and 20.0 g of 12-carboxydehydroabietic acid chloride (a-1C) obtained above as a dicarboxylic acid compound was added portionwise thereto. The reaction solution gradually became viscous. After stirring at room temperature for 8 hours, 1 L of methanol was added to the reaction solution, and the produced polymer was separated by filtration and washed with methanol. The obtained polymer was dried, heated, dissolved in 100 mL of tetrahydrofuran (THF), and poured portionwise into 1,000 mL of methanol to reprecipitate the polymer. The re-precipitate was collected and dried to obtain 21.5 g of a white solid of a polyester polymer PE-1. The weight-average molecular weight of the obtained polyester polymer PE-1 according to the above-described measuring method (solvent: NMP) was 62,000.

### Synthesis Examples PE2 to PE9

### Synthesis of Polyester Polymers PE-2 to PE-9

Each of polyester polymers PE-2 to PE-9 was synthesized in the same manner as in Synthesis Example PE1 except that, in Synthesis Example PE1, the diol compound shown in Table 1 below was used instead of hydroquinone. The weight-average molecular weight of the obtained polymer is listed in Table 1.

TABLE 1

| | Dicarboxylic acid | | Weight-average |
|---|---|---|---|
| Polymer | compound*¹ | Diol compound | molecular weight |
| PE-1 | a-1(50) | b-1(50) | 62,000 |
| PE-2 | a-1(50) | b-2(50) | 245,000 |
| PE-3 | a-1(50) | b-3(50) | 163,000 |
| PE-4 | a-1(50) | b-4(50) | 18,000 |
| PE-5 | a-1(50) | b-5(50) | 20,000 |
| PE-6 | a-1(50) | b-6(50) | 259,000 |
| PE-7 | a-1(50) | b-7(50) | 41,000 |
| PE-8 | a-1(50) | b-8(50) | 16,000 |
| PE-9 | a-1(50) | b-9(50) | 7,400 |

*¹As the dicarboxylic acid compound, 12-carboxydehydroabietic acid chloride (a-1C) in the acid chloride form was used.

In Table 1, the numbers in parentheses in the dicarboxylic acid compound and the diol compound indicate the content (% by mole) in the polyester polymer and the amount (% by mole) charged during production. The total amount of the dicarboxylic acid compound and the diol compound was 100% by mole.

In addition, the structures of the dicarboxylic acid compound and the diol compound are shown below.

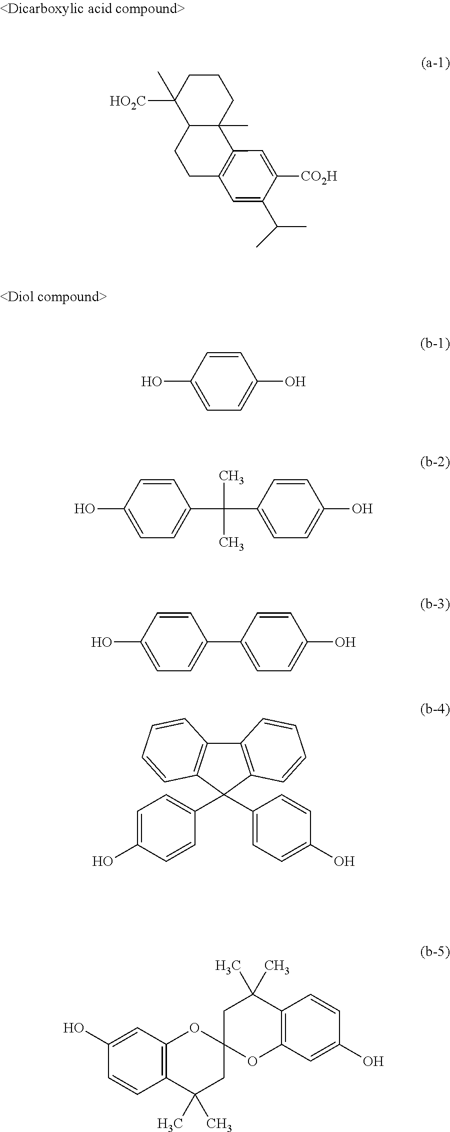 [SMILES: CC(C)c1cc2c(cc1C(=O)O)C1(C)CCCC(C)(C(=O)O)C1CC2 ; Oc1ccc(O)cc1 ; CC(C)(c1ccc(O)cc1)c1ccc(O)cc1 ; Oc1ccc(-c2ccc(O)cc2)cc1 ; Oc1ccc(C2(c3ccc(O)cc3)c3ccccc3-c3ccccc32)cc1 ; CC1(C)CC2(CC(C)(C)c3ccc(O)cc3O2)Oc2cc(O)ccc21]

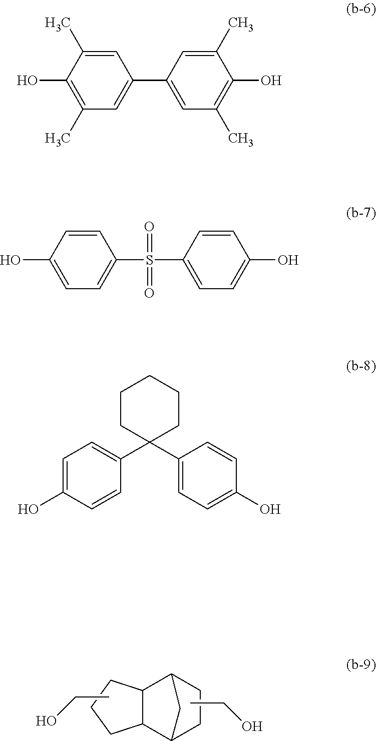

### Synthesis Example PA1

### Synthesis of polyamide polymer PA-1

A polyamide polymer PA-1 was synthesized according to the following scheme.

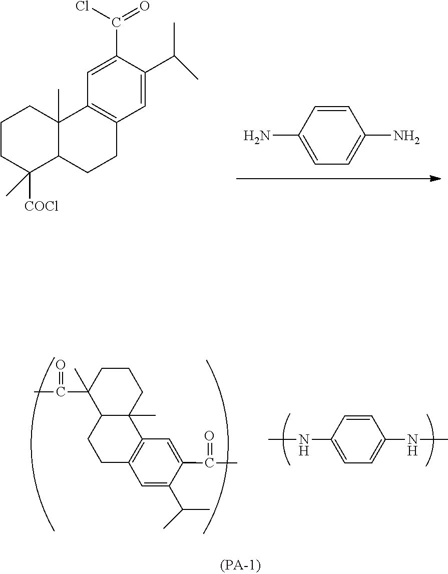

As a diamine compound, 1.08 g of a p-phenylenediamine (c-1) was added to 30 mL of pyridine and heated to 45° C. to be dissolved in a nitrogen atmosphere. The temperature of the obtained solution was cooled to 15° C., and 3.81 g of 12-carboxydehydroabietic acid chloride (a-1C) obtained above as a dicarboxylic acid compound was added portionwise thereto. The reaction solution gradually became viscous. After stirring at room temperature for 2 hours, 100 L of methanol was added to the reaction solution, and the produced polyamide polymer PA-1 was separated by filtration and washed with methanol. The obtained polyamide polymer was dried, heated, dissolved in 50 mL of dimethylformamide, and poured portionwise into 500 mL of methanol to reprecipitate the polymer. The re-precipitate was collected and dried to obtain 4.24 g of a white solid of a polyamide polymer PA-1. The weight-average molecular weight of the obtained polyamide polymer PA-1 according to the above-described measuring method (solvent: NMP) was 60,000.

### Synthesis Examples PA2 to PA5

### Synthesis of Polyamide Polymers PA-2 to PA-5

Each of polyamide polymers PA-2 to PA-5 was synthesized in the same manner as in Synthesis Example PA1 except that the diamine compound was changed to the compound shown in Table 2 below in Synthesis Example PA1. The weight-average molecular weight of the obtained polymer is listed in Table 2.

### Synthesis Example PA6

### Synthesis of Polyamide Polymer PA-6

A polyamide polymer PA-6 was synthesized according to the following scheme.

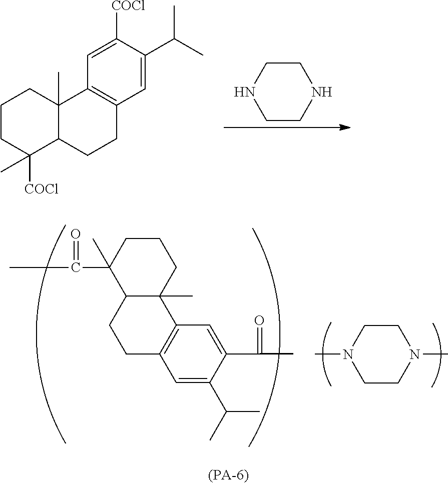

As a diamine compound, 1.08 g of piperazine (c-6) and 3.39 g of N,N-diisopropylethylamine were added to 55 mL of NMP and dissolved at room temperature under a nitrogen atmosphere. The temperature of the obtained solution was cooled to 5° C., and 4.77 g of 12-carboxydehydroabietic acid chloride (a-1C) obtained above as a dicarboxylic acid compound was added portionwise thereto. The reaction solution gradually became viscous. After stirring at room temperature for 4 hours, the reaction solution was added dropwise to 300 mL of methanol, and the produced polymer was separated by filtration and washed with methanol. The obtained polyamide polymer was dried to obtain 4.2 g of a white solid of a polyamide polymer PA-6. The weight-average molecular weight of the obtained polyamide polymer PA-6 according to the above-described measuring method (solvent: NMP) was 41,000.

### Synthesis Examples PA7 to PA11

### Synthesis of Polyamide Polymers PA-7 to PA-11

Each of polyamide polymers PA-7 to PA-11 was synthesized in the same manner as in Synthesis Example PA6 except that the diamine compound was changed to the compound shown in Table 2 below in Synthesis Example PA6. The weight-average molecular weight of the obtained polymer is listed in Table 2.

### Synthesis Example PA12

### Synthesis of Polyamide Polymer PA-12

A polyamide polymer PA-12 was synthesized according to the following scheme.

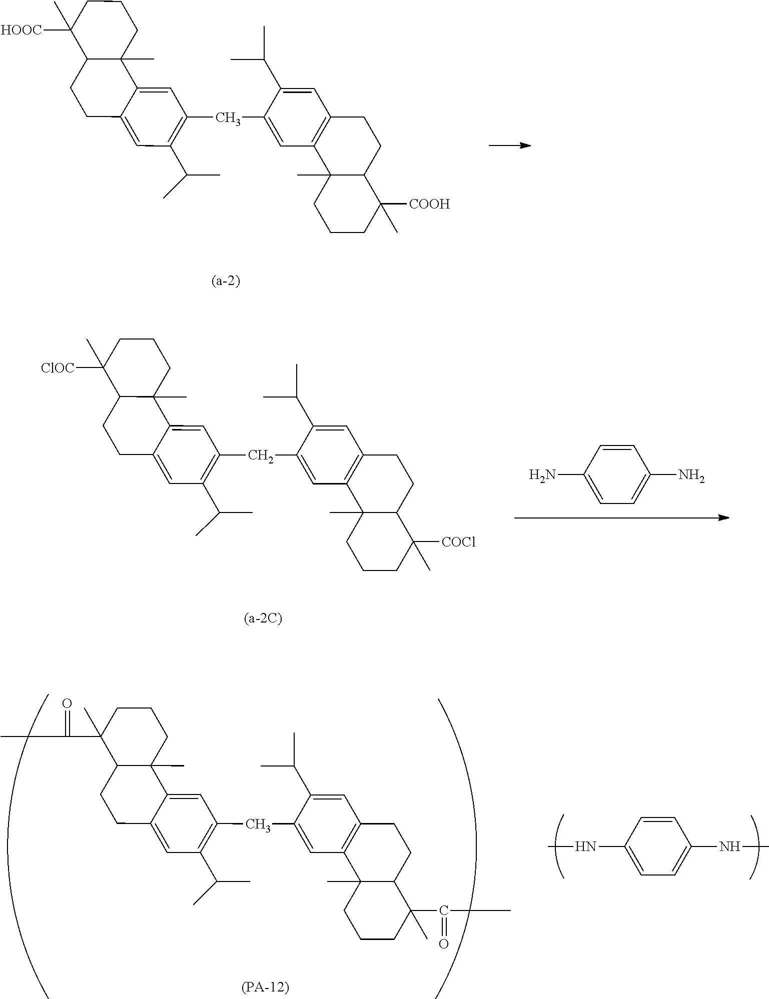

First, an acid chloride form (a-2C) of a dicarboxylic acid compound (a-2) was synthesized.

Specifically, 12.3 g of crystals of a dicarboxylic acid compound (a-2) was dispersed in 100 mL of methylene chloride, 5.59 g of oxalyl chloride, and 0.3 mL of dimethylformamide were added thereto, and the mixture was heated under reflux for 5 hours. During this period, the crystals were completely dissolved. After allowing to cool, the solvent was distilled off under reduced pressure, 10 mL of ethyl acetate and 30 mL of n-hexane were added to the residue, and an acid chloride of dicarboxylic acid (a-2C) was collected by filtration and dried under reduced pressure. The yield was 10.9 g.

Next, as a diamine compound, 1.08 g of the p-phenylenediamine (c-1) and 4.4 g of 4-dimethylaminopyridine were dissolved in 30 mL of pyridine, and under a nitrogen atmosphere, 6.50 g of an acid chloride of dicarboxylic acid (a-2C) obtained above as the dicarboxylic acid compound was added portionwise. The reaction solution was stirred at room temperature for 3 hours and poured into cold dilute hydrochloric acid, and the produced precipitate was separated by filtration and thoroughly washed with water. The obtained precipitate was dried, heated, dissolved in 80 mL of N-methylpyrrolidone, and poured portionwise into 500 mL of methanol to reprecipitate the precipitate. The re-precipitate was collected by filtration, washed with methanol, and then dried to obtain 5.8 g of a white solid of a polyamide polymer PA-12. The weight-average molecular weight of the obtained polyamide polymer PA-12 according to the above-described measuring method (solvent: NMP) was 25,000.

TABLE 2

| | Dicarboxylic acid | | Weight-average |
|---|---|---|---|
| Polymer | compound*¹ | Diol compound | molecular weight |
| PA-1 | a-1(50) | c-1(50) | 60,000 |
| PA-2 | a-1(50) | c-2(50) | 130,000 |
| PA-3 | a-1(50) | c-3(50) | 3,000 |
| PA-4 | a-1(50) | c-4(50) | 13,000 |
| PA-5 | a-1(50) | c-5(50) | 45,000 |
| PA-6 | a-1(50) | c-6(50) | 41,000 |
| PA-7 | a-1(50) | c-7(50) | 24,000 |
| PA-8 | a-1(50) | c-8(50) | 3,000 |
| PA-9 | a-1(50) | c-9(50) | 22,000 |
| PA-10 | a-1(50) | c-10(50) | 4,000 |
| PA-11 | a-1(50) | c-11(50) | 15,000 |
| PA-12 | a-2(50) | c-1(50) | 25,000 |

*¹As the dicarboxylic acid compound, 12-carboxydehydroabietic acid chloride (a-1C) in the acid chloride form or the acid chloride form (a-2C) of the dicarboxylic acid compound was used.

In Table 2, the numbers in parentheses in the dicarboxylic acid compound and the diamine compound indicate the content (% by mole) in the polyamide polymer and the amount (% by mole) charged during production. The total amount of the dicarboxylic acid compound and the diamine compound was 100% by mole.

In addition, the structures of the dicarboxylic acid compound and the diamine compound are shown below.

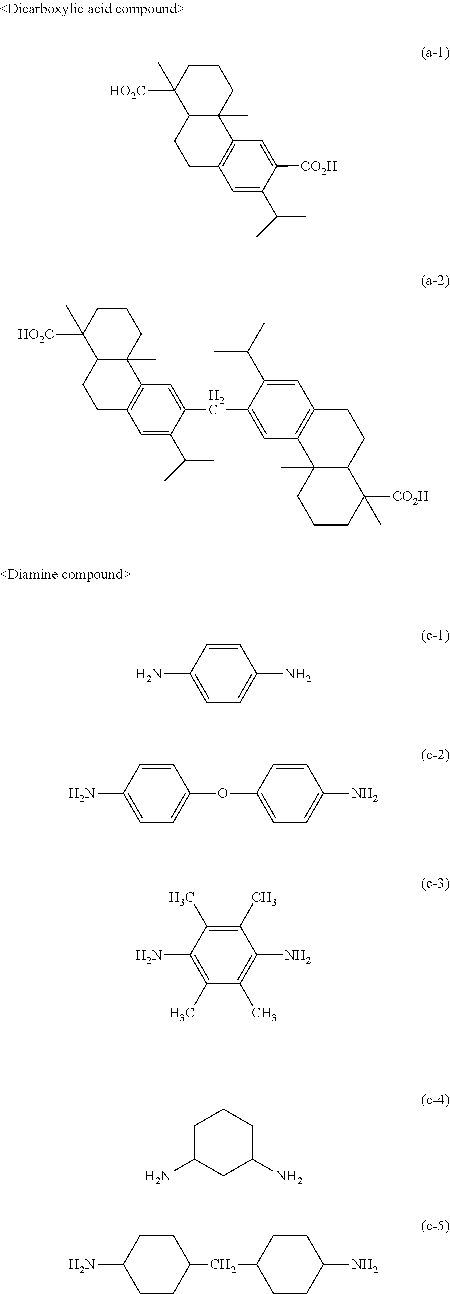

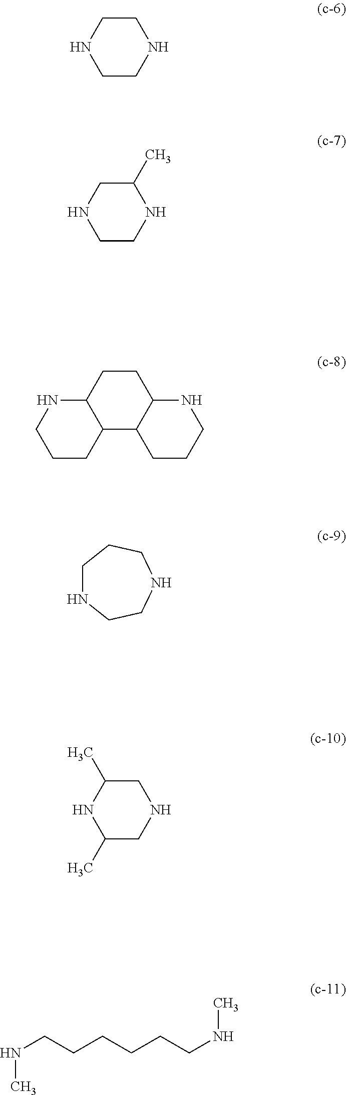

### Example 1

### Preparation of Adsorbent

Each of the synthesized polymers was sieved through a sieve having an opening of 2 mm, and those that had passed through the sieve were collected, thereby obtaining a powdery (granular) adsorbent. The average particle diameter of each adsorbent was 100 to 2,000 μm.

### Test Example 1

### <Adsorption Test>

4.68 g of sodium chloride as an osmotic pressure regulator and 10.75 g of sodium taurocholate as a pH adjuster were dissolved in 10 mmol/L (M mM) phosphate buffer having a pH of 6.0, subsequently 0.59 g (5 mM) of indole as a solute and 0.54 g (5 mM) of p-cresol were added thereto, and the mixture was uniformly dissolved to prepare a test solution (total amount: 1 L).

10 mL of the above-described test solution was added to a test tube, 20 mg of each of the prepared adsorbents was further mixed, and incubation was carried out at 37.5° C. for 1 hour. Thereafter, the obtained mixed solution was filtered using a filter having a pore diameter of 0.45 μm to obtain a supernatant solution. The reduced amounts of indole (clogD=2.2) and p-cresol (clogD=1.9) in the supernatant solution were calculated with respect to the test solution before being mixed with the adsorbent, and these reduced amounts were converted into an adsorption amount (mg/g) of each substance per 1 g of the adsorbent. The results are shown in Table 3.

The amount of solute in the supernatant solution was measured by using high performance liquid chromatography (HPLC) according to the following method and conditions, and the reduced amount of the solute in the supernatant solution was calculated from the amount of the solute in the test solution and the obtained amount of the solute.

### (HPLC Conditions)

Column: Triart C18 (manufactured by YMC CO., LTD.)

Eluent: Mixed solution of 20 mmol/L of a phosphate buffer (pH=3) and MeOH

Detection: Ultraviolet (UV) detection (wavelength: 270 nm)

Each ClogD value of the solute was a value obtained by calculating logD(7.4) of each solute with calculation software Medchem Designer (manufactured by Simulation Plus, Inc.). The same also applies to Test Example 2.

TABLE 3

| | | Adsorption amount | Adsorption amount |
|---|---|---|---|
| | | of indole | of p-cresol |
| | Adsorbent | (mg/g) | (mg/g) |
| Example 1-1 | PE-1 | 98 | 20 |
| Example 1-2 | PE-2 | 123 | 30 |
| Example 1-3 | PE-3 | 97 | 19 |
| Example 1-4 | PE-4 | 126 | 27 |
| Example 1-5 | PE-5 | 108 | 24 |
| Example 1-6 | PE-6 | 152 | 41 |
| Example 1-7 | PE-7 | 98 | 20 |
| Example 1-8 | PE-8 | 64 | 15 |
| Example 1-9 | PE-9 | 59 | 18 |
| Example 1-10 | PA-1 | 113 | 44 |
| Example 1-11 | PA-2 | 114 | 43 |
| Example 1-12 | PA-3 | 124 | 46 |
| Example 1-13 | PA-4 | 134 | 71 |
| Example 1-14 | PA-5 | 141 | 70 |
| Example 1-15 | PA-6 | 164 | 84 |
| Example 1-16 | PA-7 | 164 | 81 |
| Example 1-17 | PA-8 | 152 | 64 |
| Example 1-18 | PA-9 | 152 | 68 |
| Example 1-19 | PA-10 | 149 | 65 |
| Example 1-20 | PA-11 | 142 | 63 |
| Example 1-21 | PA-12 | 91 | 35 |

### Test Example 2

In the above <Adsorption Test> of [[Example 1]], the adsorption amount of each solute was measured in the same manner as in Example 1-15 (adsorbent PA-6) except that the adsorbates (5 mM each) shown in Table 4 below were used as solutes instead of the indole and p-cresol (5 mM each, 10 mM in total) used as the solute. The results are shown in Table 4.

TABLE 4

| | Solute | | Adsorption amount |
|---|---|---|---|
| | Adsorbate | clogD | (mg/g) |
| Test Example 2-1 | Indole | 2.2 | 255 |
| Test Example 2-2 | p-Cresol | 1.9 | 197 |
| Test Example 2-3 | Skatole | 2.6 | 308 |
| Test Example 2-4 | Phenol | 1.4 | 128 |
| Test Example 2-5 | Pyrrole | 0.7 | 37 |
| Test Example 2-6 | Pyridine | 0.6 | 16 |
| Test Example 2-7 | Anisole | 2.1 | 178 |
| Test Example 2-8 | Butyl acetate | 1.7 | 154 |
| Test Example 2-9 | Benzyl alcohol | 1.1 | 84 |

From the results shown in Table 3 and Table 4, it can be seen that the polymer according to the embodiment of the present invention can adsorb various organic substances as adsorbates, can particularly adsorb the hydrophobic (preferably clogD 1.3 or higher) organic substances in the aqueous liquid, functions as an adsorbent. It can be seen that the polyamide polymers PA-6 to PA-11 each of which has the repeating unit containing the constituent containing, in a molecular chain constituting a main chain, a DHA main skeleton and the constituent derived from an aliphatic polyamine compound containing a secondary amino group or a heterocyclic polyamine compound containing a secondary amino group have a high adsorption amount and exhibit excellent adsorption characteristics.

### Test Example 3-1

### <Adsorption Test>

In a 1 L volumetric flask, 4.68 g of sodium chloride as an osmotic pressure regulator, 10.75 g of sodium taurocholate as a pH adjuster, and 0.117 g (1 mM) of indole as a solute were weighed, 100 mL of a 100 mM phosphate buffer having a pH of 6 was added thereto, ultrapure water was added thereto such that the total amount thereof reached 1 L, and the mixture was dissolved to prepare a test solution.

In a test tube, 20 mg of PA-6 as an adsorbent was weighed, and 10 mL of the above-described test solution was added thereto. Incubation for 1 hour in a water tank adjusted to 37.5° C. was carried out. Thereafter, the obtained mixed solution was filtered using a filter having a pore diameter of 0.45 μm to obtain a supernatant solution. The measurement of the indole in the supernatant solution and the calculation of the adsorption amount were carried out in the same manner as in the above-described <Adsorption Test>of [[Example 1]]. The results are shown in Table 5.

### Test Examples 3-2 to 11

The adsorption amount of indole was calculated in the same manner as in [Test Example 3-1] described above except that the indole concentration in the solute and the incubation time in the adsorption test of [Test Example 3-1] described above were changed as shown in Table 5. The results are shown in Table 5.

TABLE 5

| | Indole | | Adsorption amount |
|---|---|---|---|
| | concentration | Incubation | (mg/g) |
| Test Example 3-1 | 1 | 1 | 46 |
| Test Example 3-2 | 1 | 8 | 51 |
| Test Example 3-3 | 5 | 1 | 145 |
| Test Example 3-4 | 5 | 2 | 169 |
| Test Example 3-5 | 5 | 4 | 173 |
| Test Example 3-6 | 5 | 8 | 183 |
| Test Example 3-7 | 5 | 24 | 202 |
| Test Example 3-8 | 10 | 1 | 258 |
| Test Example 3-9 | 10 | 8 | 287 |
| Test Example 3-10 | 20 | 1 | 387 |
| Test Example 3-11 | 20 | 8 | 363 |

### Test Example 4

### <Adsorption Test>

In a 1 L volumetric flask, 4.68 g of sodium chloride as an osmotic pressure regulator, 10.75 g of sodium taurocholate as a pH adjuster, and 100 mg of each adsorbate listed in Table 6 below as a solute were weighed, 100 mL of a 100 mM phosphate buffer having a pH of 6 was added thereto, ultrapure water was added thereto such that the total amount thereof reached 1 L, and the mixture was dissolved to prepare a test solution.

In a test tube, 20 mg of the adsorbent PA-6 was weighed, and 10 mL of the above-described test solution was added thereto. Incubation for 8 hours in a water tank adjusted to 37.5° C. was carried out. Thereafter, the obtained mixed solution was filtered using a filter having a pore diameter of 0.45 um to obtain a supernatant solution. The dissolved amount in the supernatant solution was measured according to the same method as in <Adsorption Test> described above in [[Example 1]], the reduced amount of the solute in the supernatant from was calculated the difference between the amount of solute in the test solution and the amount of solute in the supernatant solution obtained by the test, and the calculated result is divided by the amount of the solute in the test solution to calculate the adsorption rate (%). The results are shown in Table 6.

TABLE 6

| | Solute | | | |
|---|---|---|---|---|
| | | | Molecular | Adsorption |
| | Adsorbate | clogD | weight | rate (%) |
| Test Example 4-1 | Indole | 2.2 | 117 | 87 |
| Test Example 4-2 | p-Cresol | 1.9 | 108 | 73 |
| Test Example 4-3 | Skatole | 2.6 | 131 | 94 |
| Test Example 4-4 | Phenol | 1.4 | 94 | 54 |
| Test Example 4-5 | 1-Methylindole | 2.3 | 131 | 89 |
| Test Example 4-6 | Pyrrole | 0.7 | 67 | 22 |
| Test Example 4-7 | 6- | 1.7 | 133 | 81 |
| | Hydroxyindole | | | |
| Test Example 4-8 | 2-Oxindole | 0.9 | 133 | 38 |
| Test Example 4-9 | Pyridine | 0.6 | 79 | 8 |
| Test Example 4-10 | Anisole | 2.1 | 108 | 66 |
| Test Example 4-11 | Butyl acetate | 1.7 | 116 | 53 |
| Test Example 4-12 | Benzyl alcohol | 1.1 | 108 | 31 |
| Test Example 4-13 | Aspartic acid | −3.0 | 133 | 0 |
| Test Example 4-14 | Glutamic acid | −4.2 | 147 | 3 |
| Test Example 4-15 | Asparagine | −3.6 | 132 | 1 |
| Test Example 4-16 | Serin | −3.4 | 105 | 3 |
| Test Example 4-17 | Glutamine | −3.4 | 146 | 3 |
| Test Example 4-18 | Histidine | −2.9 | 155 | 2 |
| Test Example 4-19 | Glycine | −3.2 | 75 | 4 |
| Test Example 4-20 | Threonine | −3.1 | 119 | 1 |
| Test Example 4-21 | Arginine | −2.7 | 175 | 2 |
| Test Example 4-22 | Alanine | −2.8 | 89 | 2 |
| Test Example 4-23 | Tyrosine | −2.2 | 181 | 1 |
| Test Example 4-24 | Cysteine | −2.3 | 121 | 0 |
| Test Example 4-25 | Valine | −2.3 | 117 | 0 |
| Test Example 4-26 | Methionine | −2.3 | 149 | 2 |
| Test Example 4-27 | Tryptophan | −1.4 | 204 | 3 |
| Test Example 4-28 | Phenylalanine | −1.6 | 165 | 1 |
| Test Example 4-29 | Isoleucine | −2.0 | 131 | 2 |
| Test Example 4-30 | Leucine | −2.0 | 131 | 2 |
| Test Example 4-31 | Ricin | −3.4 | 146 | 5 |
| Test Example 4-32 | Proline | −2.5 | 115 | 4 |
| Test Example 4-33 | Nicardipine | 4.4 | 516 | 8 |
| | hydrochloride | | | |
| Test Example 4-34 | Furosemide | −0.2 | 331 | 4 |
| Test Example 4-35 | Warfarin | 1.1 | 308 | 2 |
| Test Example 4-36 | Captopril | −1.7 | 217 | 3 |
| Test Example 4-37 | Amlodipine | 1.4 | 409 | 6 |
| Test Example 4-38 | Propranolol | 0.9 | 296 | 5 |
| | hydrochloride | | | |
| Test Example 4-39 | Allopurinol | −0.4 | 136 | 4 |
| Test Example 4-40 | Dipyridamole | 3.0 | 505 | 8 |

As shown in Table 6, it can be seen that the adsorption rate of indole (Test Example 4-1) in [Test Example 4] was 29 times as compared to the adsorption rate of tryptophan (Test Example 4-27) which is an amino acid having a common chemical structure, and the high selective adsorption of a hydrophobic compound having a high ClogD value can be achieved. In addition, it can be seen that even a hydrophobic compound having a high ClogD value can achieve selective adsorption upon the molecular weight.

### Reference Test Example 1

### <Adsorption Test>

The adsorption test was carried out in the same manner as in Test Example 4-1 and Test Example 4-27, except that commercially available activated carbon (Kremezin fine granule sachets, manufactured by Mitsubishi Tanabe Pharma Corporation) was used as an adsorbent instead of the adsorbent PA-6 to calculate the adsorption rates of indole and tryptophan. As a result, the adsorption rate of indole was twice the adsorption rate of tryptophan.

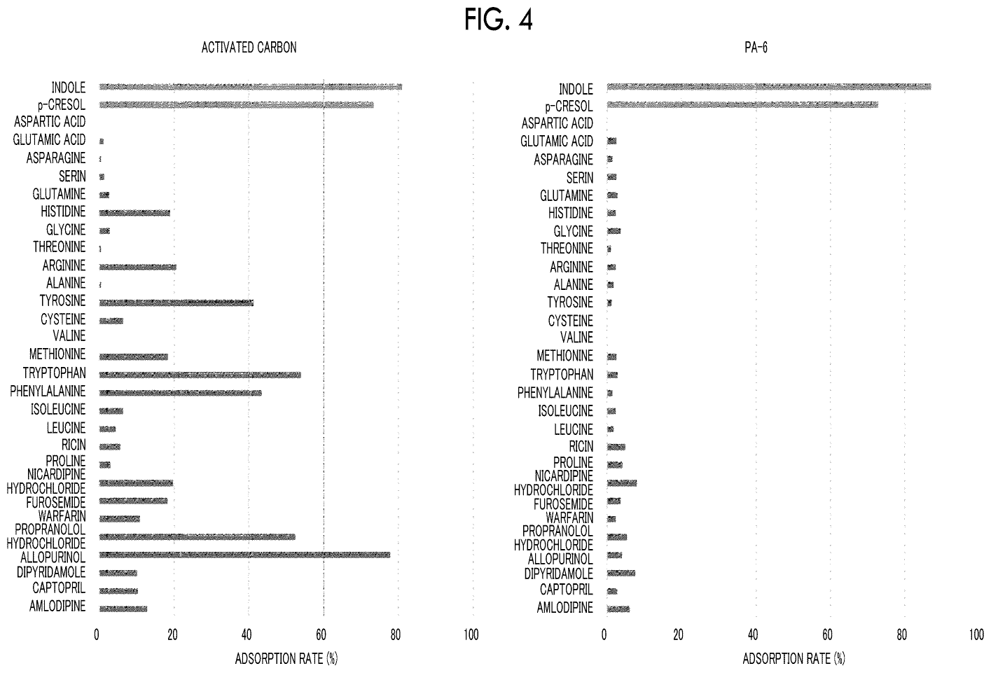

As shown in FIG. 4, there are many cases in which the activated carbon frequently used as an adsorbent adsorbs indole, p-cresol, and the like, while also adsorbing amino acids, low-molecular-weight pharmaceuticals, and the like. In contrast, the adsorbent PA-6 of the present invention can highly selectively adsorb indole, p-cresol, and the like with almost no adsorption of amino acids, a group of low-molecular-weight pharmaceuticals, and the like. Indole and p-cresol are known as precursors of uremic toxins, it is important not to adsorb amino acids, low-molecular-weight pharmaceuticals, and the like in the treatment (therapy or prevention) or the like for uremia, in a case of adsorbing and removing those in the gastrointestinal tract. That is, from the results of Test Examples 1 to 4, it can be seen that the adsorbent (the polymer) according to the embodiment of the present invention is effective for the purpose of selectively removing uremic toxin precursors (treatment for subjects suffering from uremia or subjects whose uremia is prevented).

In addition, it is possible that the adsorbent according to the embodiment of the present invention is provided to form an apparatus capable of adsorbing an adsorbate.

The present invention has been described together with the embodiment; however, unless particularly specified, the present inventors do not intend to limit the present invention to any detailed portion of the description and consider that the present invention is supposed to be broadly construed within the concept and scope of the present invention described in the claims.

What is claimed is:

1. An adsorbent comprising:
a polymer that contains a skeleton derived from a dehydroabietic acid compound in a molecular chain constituting a main chain.

2. The adsorbent according to claim 1,
wherein the skeleton derived from the dehydroabietic acid compound has a structure represented by Formula (U),
in Formula (U), R^{A} and R^{B} each represent an alkyl group having 1 to 6 carbon atoms or an alkenyl group having 2 to 6 carbon atoms, n is an integer of 0 to 4, and m is an integer of 0 to 7, Cy represents a saturated or unsaturated 6-membered ring or 7-membered ring which may contain a heteroatom, and * and ** each represent a bonding part in a case where the structure is incorporated into the molecular chain, where, in a case where n is 4, one of R^{A}'s has the bonding part *.

3. The adsorbent according to claim 1,
wherein the polymer is selected from a polymer that contains, in a molecular chain constituting a main chain, a constituent represented by Formula (A1) or (A2),
in Formulae (A1) and (A2), L¹¹, L¹², L²¹, L²², and L²³ each represent a divalent linking group, and * represents a bonding part in a case where the constituent is incorporated into the molecular chain.

4. The adsorbent according to claim 1,
wherein the polymer contains, in the molecular chain, a constituent derived from a polyamine compound or a polyol compound.

5. The adsorbent according to claim 4,
wherein the polyamine compound contains a secondary amino group.

6. The adsorbent according to claim 4,
wherein the polyamine compound contains a heterocyclic structure.

7. The adsorbent according to claim 1,
wherein the adsorbent is used in a liquid containing water.

8. The adsorbent according to claim 1,
wherein an adsorbate is an organic substance.

9. The adsorbent according to claim 8,
wherein the organic substance is a compound having a clogD>0.

10. An adsorption apparatus comprising the adsorbent according to claim 1.

11. A polymer comprising, in a molecular chain constituting a main chain:
a constituent that contains a skeleton derived from a dehydroabietic acid compound; and
a constituent derived from a polyamine compound that contains a secondary amino group.

12. The polymer according to claim 11,
wherein the polyamine compound contains a heterocyclic structure.
